(19) United States
(12) Patent Application Publication
(10) Pub. No.: US 2025/0212247 A1
(43) Pub. Date: Jun. 26, 2025

(54) PRIORITIZATION AND MULTIPLEXING FRAMEWORK

(71) Applicant: QUALCOMM Incorporated, San Diego, CA (US)

(72) Inventors: Yi HUANG, San Diego, CA (US); Jing SUN, San Diego, CA (US); Mostafa KHOSHNEVISAN, San Diego, CA (US); Kianoush HOSSEINI, San Diego, CA (US)

(21) Appl. No.: 18/393,404

(22) Filed: Dec. 21, 2023

(51) Int. Cl. H04W 72/566

(52) U.S. Cl. CPC H04W 72/566

(57) ABSTRACT

Methods, systems, and devices for wireless communications are described. A user equipment (UE) may receive from a network entity, one or more first signaling messages that schedule one or more wireless messages. The one or more first signaling messages may indicate a respective priority associated with each wireless message of the one or more wireless messages. In some examples, the UE may receive a second signaling message that indicates a priority threshold, where the second signaling message indicates for the UE to adjust a communication of any wireless message that has a priority less than the priority threshold (e.g., perform one or more multiplexing procedures, one or more prioritization procedures, or a combination thereof). As such, the UE may communicate at least a portion of the one or more wireless messages based at least in part on the priority threshold.

### FIELD OF TECHNOLOGY

The following relates to wireless communications, including prioritization and multiplexing framework.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support prioritization and multiplexing framework. For example, the described techniques provide for performing prioritization and multiplexing. For example, a network entity and one or more user equipments (UEs) may operate in accordance with a common prioritization and multiplexing framework.

For inter-UE prioritization, one or more UEs may use a set of global priorities that may be configured at a network entity. For example, the network entity may transmit to a set of UEs, a set of control messages that schedule respective wireless messages at each of the set of UEs (e.g., uplink messages, downlink messages, or both). Additionally, the set of control messages may indicate a global priority associated with each of the scheduled wireless message. As such, if the network entity determines that one or more scheduled wireless messages are to be dropped, the network entity may transmit a group common downlink control information (GC-DCI) message that indicates a global priority threshold that the set of UEs may use to determine whether to drop any scheduled wireless messages during an indicated region of the communication resources. For example, the set of UEs may drop any wireless messages that overlap with the indicated region of communication resources and have a global priority less than the global priority threshold.

For intra-UE prioritization, a given UE may use the set of global priorities to determine which wireless messages to drop in cases where two or more messages overlap in communication resources (e.g., time and/or frequency). For example, a first UE may start from the wireless message with the highest priority level and drop any lower priority wireless messages that overlap with the highest priority wireless message. As such, the UE may move one priority lower and repeat the dropping procedure until no scheduled wireless messages overlap in communication resources (e.g., time and/or frequency).

For intra-UE multiplexing, a given UE may receive a message from the network entity that enables multiplexing capabilities at the given UE. In some examples of multiplexing enablement, the network entity may transmit a scheduling DCI that indicates a multiplexing threshold. As such, the UE may drop any wireless messages that overlap and have a global priority less than the multiplex threshold and multiplex any wireless messages that overlap and have a global priority greater than or equal to the multiplex threshold. In some examples of multiplexing enablement, the UE may receive a multiplexing indicator for each scheduled wireless message. If the multiplex indicator is of a first value, it may indicate that the channel associated with the given wireless message may not allow multiplexing. If the multiplex indicator is of a second value, it may indicate that the channel associated with the given wireless message may allow multiplexing. As such, the UE may multiplex wireless messages that overlap onto a same channel that is associated with the second value of the multiplexing indicator.

A method for wireless communications by a UE is described. The method may include receiving one or more first signaling messages that schedule one or more wireless messages, the one or more first signaling messages indicating a respective priority associated with each wireless message of the one or more wireless messages, receiving a second signaling message that indicates a priority threshold, where the second signaling message indicates for the UE to adjust a communication of any wireless messages that have a priority less than the priority threshold, and communicating at least a portion of the one or more wireless messages based on the priority threshold.

A UE for wireless communications is described. The UE may include one or more memories storing processor executable code, and one or more processors coupled with the one or more memories. The one or more processors may individually or collectively operable to execute the code to cause the UE to receive one or more first signaling messages that schedule one or more wireless messages, the one or more first signaling messages indicating a respective priority associated with each wireless message of the one or more wireless messages, receive a second signaling message that indicates a priority threshold, where the second signaling message indicates for the UE to adjust a communication of any wireless messages that have a priority less than the priority threshold, and communicate at least a portion of the one or more wireless messages based on the priority threshold.

Another UE for wireless communications is described. The UE may include means for receiving one or more first signaling messages that schedule one or more wireless messages, the one or more first signaling messages indicating a respective priority associated with each wireless message of the one or more wireless messages, means for receiving a second signaling message that indicates a priority threshold, where the second signaling message indicates for the UE to adjust a communication of any wireless messages that have a priority less than the priority threshold, and means for communicating at least a portion of the one or more wireless messages based on the priority threshold.

A non-transitory computer-readable medium storing code for wireless communications is described. The code may include instructions executable by one or more processors to receive one or more first signaling messages that schedule one or more wireless messages, the one or more first signaling messages indicating a respective priority associated with each wireless message of the one or more wireless messages, receive a second signaling message that indicates a priority threshold, where the second signaling message indicates for the UE to adjust a communication of any wireless messages that have a priority less than the priority threshold, and communicate at least a portion of the one or more wireless messages based on the priority threshold.

Some examples of the method, UEs, and non-transitory computer-readable medium described herein may further include operations, features, means, or instructions for receiving a radio resource control (RRC) message that maps a set of global priorities to a set of local priorities used by the UE, where the one or more wireless messages may be mapped from a highest local priority to a lowest local priority in accordance with a mapping between the set of global priorities and the set of local priorities.

In some examples of the method, UEs, and non-transitory computer-readable medium described herein, a first quantity of local priorities used by the UE may be less than a second quantity of global priorities configured by a network entity.

In some examples of the method, UEs, and non-transitory computer-readable medium described herein, the second signaling message further indicates a region of communication resources and the method, apparatuses, and non-transitory computer-readable medium may include further operations, features, means, or instructions for dropping, for the region of the communication resources, a subset of wireless messages of the one or more wireless messages based on each wireless message of the subset of wireless messages being associated with respective priorities that may be less than the priority threshold, where communicating at least the portion of the one or more wireless messages may be based on the dropping.

In some examples of the method, UEs, and non-transitory computer-readable medium described herein, the region of the communication resources includes a set of time resources and a set of frequency resources.

Some examples of the method, UEs, and non-transitory computer-readable medium described herein may further include operations, features, means, or instructions for receiving a signaling message of the one or more first signaling messages that configures a flexible channel, where the flexible channel may be configurable as an uplink channel associated with a first priority or a downlink channel associated with a second priority, and where one of the first priority and the second priority may be greater than or equal to the priority threshold and determining that the flexible channel may be the uplink channel or the downlink channel in accordance with which one of the first priority and the second priority may be greater than or equal to the priority threshold, where communicating at least the portion of the one or more wireless messages may be based on the determining.

In some examples of the method, UEs, and non-transitory computer-readable medium described herein, communicating at least the portion of the one or more wireless messages may include operations, features, means, or instructions for dropping a first wireless message of the one or more wireless messages that may be associated with a first priority based on the first wireless message at least partially overlapping in time with a second wireless message of the one or more wireless messages that may be associated with associated with a second priority greater than the first priority.

Some examples of the method, UEs, and non-transitory computer-readable medium described herein may further include operations, features, means, or instructions for receiving a third signaling message that enables multiplexing across multiple wireless messages transmitted by the UE.

Some examples of the method, UEs, and non-transitory computer-readable medium described herein may further include operations, features, means, or instructions for receiving a scheduling DCI message that schedules a first wireless message of the one or more wireless messages and indicates a multiplexing threshold for the first wireless message, where receiving the scheduling DCI message indicates for the UE to adjust the communication of the one or more wireless messages in accordance with the multiplexing threshold.

In some examples of the method, UEs, and non-transitory computer-readable medium described herein, adjusting the communication of the one or more wireless messages in accordance with the multiplexing threshold may include operations, features, means, or instructions for dropping any wireless messages that at least partially overlap in time with the first wireless message and may be associated with a priority that may be less than the multiplexing threshold and multiplexing wireless messages that at least partially overlap in time with the first wireless message and may be associated with respective priorities that may be greater than or equal to the multiplexing threshold.

Some examples of the method, UEs, and non-transitory computer-readable medium described herein may further include operations, features, means, or instructions for receiving, as part of the one or more first signaling messages, a respective multiplexing indicator associated with each wireless message of the one or more wireless messages, where the respective multiplexing indicator indicates whether an associated wireless message may be configured for multiplexing with other wireless messages.

Some examples of the method, UEs, and non-transitory computer-readable medium described herein may further include operations, features, means, or instructions for multiplexing a first wireless message of the one or more wireless messages with a second wireless message of the one or more wireless messages based on the second wireless message being associated with a respective multiplexing indicator that indicates that the second wireless message may be configured for multiplexing.

Some examples of the method, UEs, and non-transitory computer-readable medium described herein may further include operations, features, means, or instructions for multiplexing the first wireless message with a third wireless message of the one or more wireless messages based on the third wireless message being associated with a respective multiplexing indicator that indicates that the third wireless message may be configured for multiplexing.

In some examples of the method, UEs, and non-transitory computer-readable medium described herein, the second signaling message may be a GC-DCI message that may be associated with a set of multiple UEs including the UE.

A method for wireless communications by a network entity is described. The method may include outputting, to a set of multiple UEs, one or more first signaling messages that schedule respective one or more wireless messages for each UE of the set of multiple UEs, the one or more first signaling messages indicating a respective priority associated with each wireless message of the respective one or more wireless messages, outputting, to the set of multiple UEs, a second signaling message that indicates a priority threshold, where outputting the second signaling message indicates for the set of multiple UEs to adjust a communication of any wireless messages that have a priority less than the priority threshold, and communicating, with the set of multiple UEs, at least a portion of the respective one or more wireless messages based on the priority threshold.

A network entity for wireless communications is described. The network entity may include one or more memories storing processor executable code, and one or more processors coupled with the one or more memories. The one or more processors may individually or collectively operable to execute the code to cause the network entity to output, to a set of multiple UEs, one or more first signaling messages that schedule respective one or more wireless messages for each UE of the set of multiple UEs, the one or more first signaling messages indicating a respective priority associated with each wireless message of the respective one or more wireless messages, output, to the set of multiple UEs, a second signaling message that indicates a priority threshold, where outputting the second signaling message indicates for the set of multiple UEs to adjust a communication of any wireless messages that have a priority less than the priority threshold, and communicate, with the set of multiple UEs, at least a portion of the respective one or more wireless messages based on the priority threshold.

Another network entity for wireless communications is described. The network entity may include means for outputting, to a set of multiple UEs, one or more first signaling messages that schedule respective one or more wireless messages for each UE of the set of multiple UEs, the one or more first signaling messages indicating a respective priority associated with each wireless message of the respective one or more wireless messages, means for outputting, to the set of multiple UEs, a second signaling message that indicates a priority threshold, where outputting the second signaling message indicates for the set of multiple UEs to adjust a communication of any wireless messages that have a priority less than the priority threshold, and means for communicating, with the set of multiple UEs, at least a portion of the respective one or more wireless messages based on the priority threshold.

A non-transitory computer-readable medium storing code for wireless communications is described. The code may include instructions executable by one or more processors to output, to a set of multiple UEs, one or more first signaling messages that schedule respective one or more wireless messages for each UE of the set of multiple UEs, the one or more first signaling messages indicating a respective priority associated with each wireless message of the respective one or more wireless messages, output, to the set of multiple UEs, a second signaling message that indicates a priority threshold, where outputting the second signaling message indicates for the set of multiple UEs to adjust a communication of any wireless messages that have a priority less than the priority threshold, and communicate, with the set of multiple UEs, at least a portion of the respective one or more wireless messages based on the priority threshold.

Some examples of the method, network entities, and non-transitory computer-readable medium described herein may further include operations, features, means, or instructions for outputting, to each UE of the set of multiple UEs, a respective RRC message that maps a set of global priorities to a respective set of local priorities used by a respective UE of the set of multiple UEs, where the respective one or more wireless messages for the respective UE may be mapped from a highest local priority to a lowest local priority in accordance with a mapping between the set of global priorities and the respective set of local priorities.

In some examples of the method, network entities, and non-transitory computer-readable medium described herein, the second signaling message indicates for the set of multiple UEs to drop wireless messages associated with respective priorities that may be less than the priority threshold.

Some examples of the method, network entities, and non-transitory computer-readable medium described herein may further include operations, features, means, or instructions for outputting, to a first UE of the set of multiple UEs, a signaling message of the one or more first signaling messages that configures a flexible channel, where the flexible channel may be configurable as an uplink channel associated with a first priority or a downlink channel associated with a second priority, and where one of the first priority and the second priority may be greater than or equal to the priority threshold and scheduling the flexible channel as the uplink channel or the downlink channel in accordance with which one of the first priority and the second priority may be greater than or equal to the priority threshold, where communicating at least the portion of the respective one or more wireless messages may be based on the scheduling.

Some examples of the method, network entities, and non-transitory computer-readable medium described herein may further include operations, features, means, or instructions for outputting, to a first UE of the set of multiple UEs, a third signaling message that enables multiplexing across multiple wireless messages outputted by the first UE.

Some examples of the method, network entities, and non-transitory computer-readable medium described herein may further include operations, features, means, or instructions for outputting, to the first UE, a scheduling DCI message that schedules a first wireless message of the respective one or more wireless messages and indicates a multiplexing threshold for the first wireless message, where outputting the scheduling DCI message indicates for the first UE to adjust the communication of the respective one or more wireless messages in accordance with the multiplexing threshold.

In some examples of the method, network entities, and non-transitory computer-readable medium described herein, the multiplexing threshold indicates for the first UE to drop any wireless messages that at least partially overlap in time with the first wireless message and may be associated with a priority that may be less than the multiplexing threshold, and to multiplex any wireless messages that at least partially overlap in time with the first wireless message and may be associated with respective priorities that may be greater than or equal to the multiplexing threshold.

Some examples of the method, network entities, and non-transitory computer-readable medium described herein may further include operations, features, means, or instructions for outputting, as part of the one or more first signaling messages, a respective multiplexing indicator associated with each wireless message of the respective one or more wireless messages associated with the first UE, where the respective multiplexing indicator indicates whether an associated wireless message may be configured for multiplexing with other wireless messages.

In some examples of the method, network entities, and non-transitory computer-readable medium described herein, the second signaling message may be a GC-DCI message that may be associated with the set of multiple UEs.

### BRIEF DESCRIPTION OF THE DRAWINGS

FIG. 1 shows an example of a wireless communications system that supports prioritization and multiplexing framework in accordance with one or more aspects of the present disclosure.

FIG. 2 shows an example of a wireless communications system that supports prioritization and multiplexing framework in accordance with one or more aspects of the present disclosure.

FIG. 3 shows an example of an inter-user equipment (UE) message prioritization procedure that supports prioritization and multiplexing framework in accordance with one or more aspects of the present disclosure.

FIG. 4 shows an example of an intra-UE message prioritization and multiplexing procedure that supports prioritization and multiplexing framework in accordance with one or more aspects of the present disclosure.

FIGS. 5A and 5B each show an example of an intra-UE message multiplexing procedure that supports prioritization and multiplexing framework in accordance with one or more aspects of the present disclosure.

FIG. 6 shows an example of a process flow that supports prioritization and multiplexing framework in accordance with one or more aspects of the present disclosure.

FIGS. 7 and 8 show block diagrams of devices that support prioritization and multiplexing framework in accordance with one or more aspects of the present disclosure.

FIG. 9 shows a block diagram of a communications manager that supports prioritization and multiplexing framework in accordance with one or more aspects of the present disclosure.

FIG. 10 shows a diagram of a system including a device that supports prioritization and multiplexing framework in accordance with one or more aspects of the present disclosure.

FIGS. 11 and 12 show block diagrams of devices that support prioritization and multiplexing framework in accordance with one or more aspects of the present disclosure.

FIG. 13 shows a block diagram of a communications manager that supports prioritization and multiplexing framework in accordance with one or more aspects of the present disclosure.

FIG. 14 shows a diagram of a system including a device that supports prioritization and multiplexing framework in accordance with one or more aspects of the present disclosure.

FIGS. 15 through 18 show flowcharts illustrating methods that support prioritization and multiplexing framework in accordance with one or more aspects of the present disclosure.

### DETAILED DESCRIPTION

In some examples of wireless communications one or more wireless devices may use a message prioritization and multiplexing framework. For example, a prioritization and multiplexing framework may include techniques for managing the communication of messages across multiple user equipments (UEs) (e.g., inter-UE prioritization and multiplexing) and for wireless messages at a single UE (e.g., intra-UE prioritization and multiplexing). In some examples, message prioritization may include process for one or more UEs to determine which messages to drop when two or more messages overlap in communication resources (e.g., time and/or frequency). In some cases, prioritization may be triggered by one or more network indications. For instance, a network entity may transmit to a given UE one or more types of indicators that indicate whether a UE may drop a given scheduled wireless message. The types of indicators the network entity may transmit include one or more of a cancellation indicator (CI), a preemption indicator (PI), and slot format indicator (SFI). Additionally, intra-prioritization at a given UE may include an additional set of procedures in which the UE compares multiple wireless message types and associated priorities to determine which scheduled messages may be transmitted, and which other scheduled messages may be dropped. Additionally, message multiplexing may include a process for a given UE to determine whether two or more wireless messages that at least partially overlap in communication resources (e.g., time and/or frequency) may be multiplexed onto a same frequency channel for transmission. As such, UE multiplexing may include another set of procedures to determine whether to multiplex multiple wireless messages. In some cases, however, the interlacing of prioritization procedures and multiplexing procedures across wireless messages for a single UE (e.g., intra-UE) and wireless messages across multiple UEs (e.g., inter-UE) may increase the complexity of the signaling. For instance, signaling of multiple types of respective priority indicators (e.g., PI, CI, and SFI) to respective UEs 115 may increase signaling overhead of the system. Additionally, or alternatively, having multiple UEs 115 perform multiplexing may increase the energy consumption at each UE 115 while increasing latency for the network.

As such, a network entity and serviced UEs may reduce power consumption, latency, and signaling overhead associated with performing prioritization and multiplexing by operating in accordance with the techniques described herein. For example, the network entity and UEs may operate in accordance with a common prioritization and multiplexing framework. Various aspects of the common prioritization and multiplexing framework are described herein.

For inter-UE prioritization, one or more UEs may use a set of global priorities that may be configured at a network entity. For example, the network entity may transmit to a set of UEs, a set of control messages that schedule respective wireless messages at each of the set of UEs (e.g., uplink messages, downlink messages, or both). Additionally, the set of control messages may indicate a global priority associated with each of the scheduled wireless message. As such, if the network entity determines that one or more scheduled wireless messages are to be dropped, the network entity may transmit a group common downlink control information (GC-DCI) message that indicates a global priority threshold that the set of UEs may use to determine whether to drop any scheduled wireless messages during an indicated region of the communication resources. For example, the set of UEs may drop any wireless messages that overlap with the indicated region of communication resources and have a global priority less than the global priority threshold.

For intra-UE prioritization, a given UE may use the set of global priorities to determine which wireless messages to drop in cases where two or more messages overlap in communication resources (e.g., time and/or frequency). For example, a first UE may start from the wireless message with the highest priority level and drop any lower priority wireless messages that overlap with the highest priority wireless message. As such, the UE may move one priority lower and repeat the dropping procedure until no scheduled wireless messages overlap in time.

For intra-UE multiplexing, a given UE may receive a message from the network entity that enables multiplexing capabilities at the given UE. In some examples of multiplexing enablement, the network entity may transmit a scheduling DCI that indicates a multiplexing threshold. As such, the UE may drop any wireless messages that overlap and have a global priority less than the multiplex threshold and multiplex any wireless messages that overlap and have a global priority greater than or equal to the multiplex threshold. In some examples of multiplexing enablement, the UE may receive a multiplexing indicator for each scheduled wireless message. If the multiplex indicator is of a first value, it may indicate that the channel associated with the given wireless message may not allow multiplexing. If the multiplex indicator is of a second value, it may indicate that the channel associated with the given wireless message may allow multiplexing. As such, the UE may multiplex wireless messages that overlap onto a same channel that is associated with the second value of the multiplexing indicator.

By operating with the priority threshold, the network may use a single set of priorities to indicate to multiple UEs how to prioritize and multiplex one or more respectively scheduled wireless messages, which may reduce signaling overhead of the network. Additionally, by enabling multiplexing procedures on a per UE basis, the network entity may reduce complexity associated with performing both prioritization and multiplexing at each UE, which may reduce signaling overhead and energy consumption at the UEs.

Aspects of the disclosure are initially described in the context of wireless communications systems, an inter-UE message prioritization procedure, an intra-UE message prioritization and multiplexing procedure, intra-UE multiplexing procedures, and a process flow. Aspects of the disclosure are further illustrated by and described with reference to apparatus diagrams, system diagrams, and flowcharts that relate to prioritization and multiplexing framework.

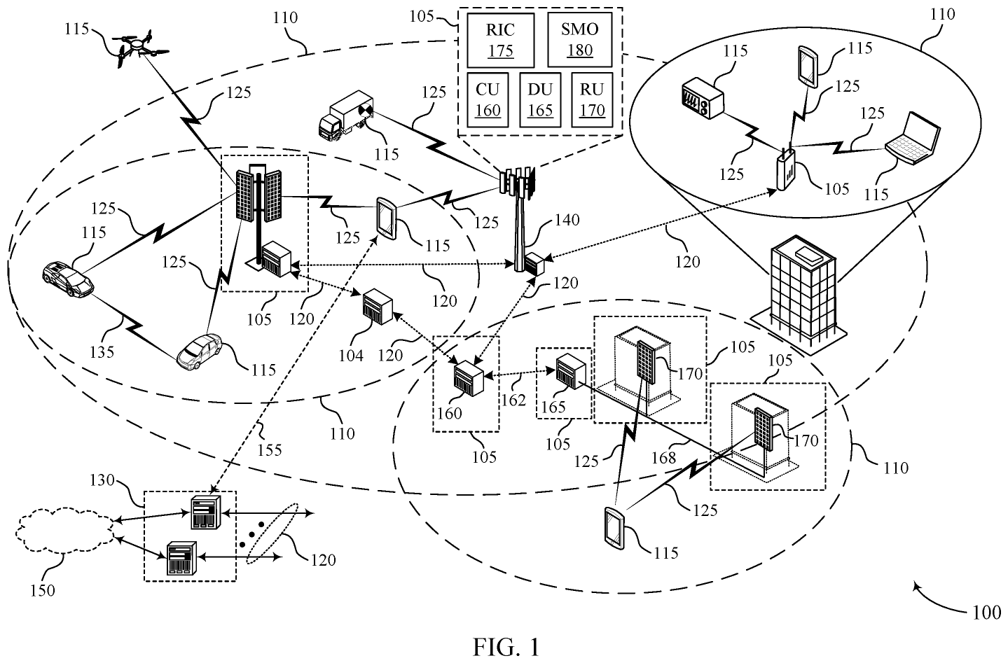

FIG. 1 shows an example of a wireless communications system 100 that supports prioritization and multiplexing framework in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support prioritization and multiplexing framework as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of wireless communications system 100, a network entity 105 and one or more UEs 115 may operate in accordance with a common prioritization and multiplexing framework.

For inter-UE prioritization, one or more UEs 115 may use a set of global priorities that may be configured at a network entity 105. For example, the network entity 105 may transmit to a set of UEs 115, a set of control messages that schedule respective wireless messages at each of the set of UEs 115 (e.g., uplink messages, downlink messages, or both). Additionally, the set of control messages may indicate a global priority associated with each of the scheduled wireless message. As such, if the network entity 105 determines that one or more scheduled wireless messages are to be dropped, the network entity 105 may transmit a GC-DCI message that indicates a global priority threshold that the set of UEs 115 may use to determine whether to drop any scheduled wireless messages during an indicated region of the communication resources. For example, the set of UEs 115 may drop any wireless messages that overlap with the indicated region of communication resources and have a global priority less than the global priority threshold.

For intra-UE prioritization, a given UE 115 may use the set of global priorities to determine which wireless messages to drop in cases where two or more messages overlap in communication resources (e.g., time and/or frequency). For example, a first UE 115 may start from the wireless message with the highest priority level and drop any lower priority wireless messages that overlap with the highest priority wireless message. As such, the UE 115 may move one priority lower and repeat the dropping procedure until no scheduled wireless messages overlap in communication resources (e.g., time and/or frequency).

For intra-UE multiplexing, a given UE 115 may receive a message from the network entity 105 that enables multiplexing capabilities at the given UE. In some examples of multiplexing enablement, the network entity 105 may transmit a scheduling DCI that indicates a multiplexing threshold. As such, the UE 115 may drop any wireless messages that overlap and have a global priority less than the multiplex threshold and multiplex any wireless messages that overlap and have a global priority greater than or equal to the multiplex threshold. In some examples of multiplexing enablement, the UE 115 may receive a multiplexing indicator for each scheduled wireless message. If the multiplex indicator is of a first value, it may indicate that the channel associated with the given wireless message may not allow multiplexing. If the multiplex indicator is of a second value, it may indicate that the channel associated with the given wireless message may allow multiplexing. As such, the UE 115 may multiplex wireless messages that overlap onto a same channel that is associated with the second value of the multiplexing indicator.

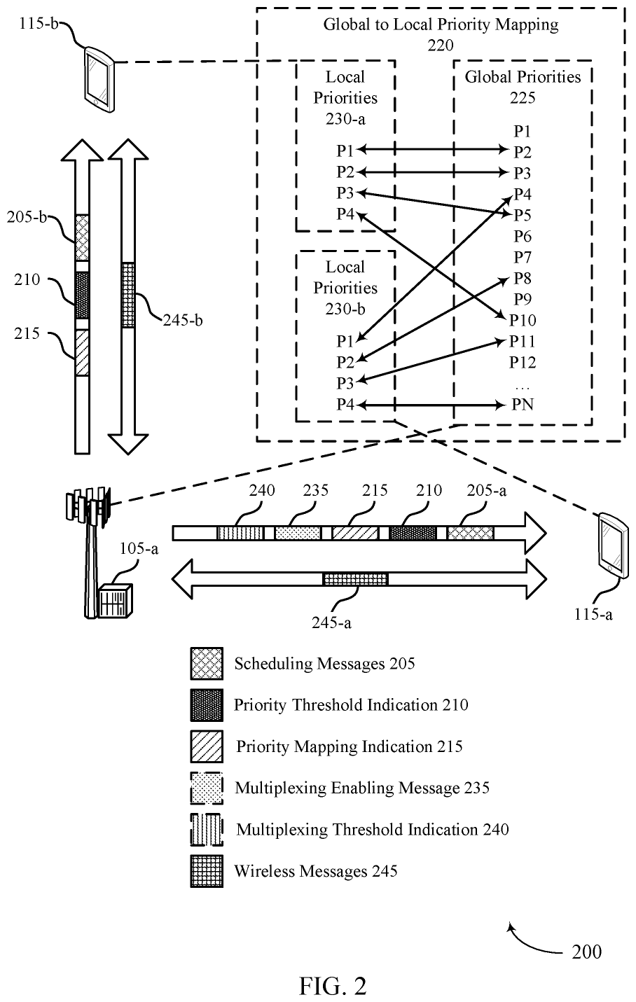

FIG. 2 shows an example of a wireless communications system 200 that supports prioritization and multiplexing framework in accordance with one or more aspects of the present disclosure. In some examples, the wireless communications system 200 may implement aspects of the wireless communications system 100. For example, the wireless communications system 200 may include a UE 115-a, a UE 115-b, and a network entity 105-a which may be examples of UEs 115 and a network entity 105, as described with reference to FIG. 1.

As illustrated in FIG. 2, the UEs 115 may communicate respective wireless messages 245 with the network entity 105-a. For example, the UE 115-a may communicate wireless messages 245-a and the UE 115-b may communicate wireless messages 245-b. In some cases, the respective wireless messages 245 may be examples of uplink messages, such as physical uplink shared channel (PUSCH) messages, physical uplink control channel (PUCCH) messages, uplink control information (UCI) messages, control state information (CSI) messages, acknowledgement (ACK) messages, HARQ-ACK messages, or a combination thereof. Additionally, or alternatively, the respective wireless messages 245 may be examples of downlink messages, such as physical downlink shared channel (PDSCH) messages, physical downlink control channel (PDCCH) messages, downlink control information (DCI) messages, ACK messages, HARQ-ACK messages, or a combination thereof.

In some examples, the network entity 105-a may transmit to each of the UEs 115 a respective set of scheduling messages 205 that schedule the respective wireless messages 245. For instance, the network entity 105-a may transmit to the UE 115-a one or more scheduling messages 205-a to schedule the one or more wireless messages 245-a and may transmit to the UE 115-b one or more scheduling messages 205-b to schedule the one or more wireless messages 245-b. The one or more respective scheduling messages 205 may be examples of one or more DCI messages, one or more RRC messages, or a combination thereof. Additionally, or alternatively, a given scheduling message 205 may schedule one or more wireless messages 245 for the associated UE 115. For instance, a single scheduling message 205-a may schedule multiple wireless messages 245-a for the UE 115-a, a single scheduling message 205-a may schedule a single wireless message 245-a for the UE 115-a, or a combination thereof.

In some cases, the scheduling messages 205 may indicate a set of communication resources (e.g., frequency and time resources) for each of the scheduled one or more wireless messages 245. For example, a given wireless message 245 may span one or more frequency resources (e.g., resource elements (REs), sub-carriers, carriers, or channels) and one or more time resources (e.g., slot, sub-slot, symbol, or frame). Additionally, or alternatively, one or more of the scheduled wireless messages 245 may be associated with communication resources that at least partially overlap with other scheduled wireless messages 245. For instance, the UE 115-a may experience intra-UE message overlap, where one or more wireless messages 245-a at least partially overlap in time or frequency.

As such, each respective UE 115 may perform one or more prioritization procedures and/or one or more multiplexing procedures to resolve intra-UE overlapping wireless messages. For example, the UE 115-a may resolve two overlapping PUCCHs associated with repetitions by dropping a first PUCCH for a first repetition and dropping a second PUCCH for a second repetition. Additionally, or alternatively the UE 115-a may resolve two overlapping PUCCHs that may not be associated with repetitions by multiplexing the first PUCCH with the second PUCCH on a same frequency channel. Further, the UE 115-a may perform the same prioritization procedures or multiplexing procedures for two overlapping PUSCHs.

Additionally, or alternatively, one or more wireless messages 245-a may at least partially overlap with one or more wireless messages 245-b (e.g., inter-UE message overlap). As such, the UE 115-a and the UE 115-b may perform one or more prioritization procedures and/or one or more multiplexing procedures to resolve inter-UE overlapping wireless messages 245. For example, the UE 115-a and UE 115-b may each be scheduled with a respective PUCCH that is associated with a respective priority. In such an example, the UE 115-a and UE 115-b may resolve the overlapping PUCCHs by dropping the PUCCH with a lower associated priority, or by multiplexing the two PUCCHs on a same frequency channel. Further, the UE 115-a and UE 115-b may perform the same prioritization procedures or multiplexing procedures for two overlapping PUSCHs. Additionally, or alternatively, the UE 115-a may be scheduled with a PUSCH that may at least partially overlap with a PUCCH scheduled for the UE 115-b, or vice versa. In such an example, the UE 115-a and UE 115-b may resolve the overlapping PUCCH and PUSCH by dropping one of the PUCCH or PUSCH that is associated with a lower priority, or by multiplexing the PUCCH and PUSCH on a same frequency channel.

Additionally, or alternatively, the UEs 115 may prioritize and multiplex wireless messages 245 in accordance with one or more indications from the network entity 105-a. In some examples, the network entity 105-a may transmit or output a PI associated with a given wireless message 245. For instance, a PI may be a signal or mechanism used to indicate preempting of an ongoing communication session or resource allocation in favor of a higher-priority service or user. That is, the UE 115-a may receive a PI associated with one or more wireless messages 245-a, where the UE 115-a may drop the one or more indicated wireless messages 245-a. In some examples, the network entity 105-a may transmit or output a CI associated with a given wireless message 245. For instance, a CI may be a signal or mechanism used to indicate cancellation of an ongoing communication session or resource allocation. That is, the UE 115-a may receive a CI associated with one or more wireless messages 245-a, where the UE 115-a may cancel (e.g., drop) the one or more indicated wireless messages 245-a. In some examples, the network entity 105-a may transmit or output an SFI associated with a given wireless message 245. For example, the network entity 105-a may schedule a slot of the UE 115-a as an uplink slot (e.g., a slot for transmitting uplink messages), a downlink slot (e.g., a slot for receiving downlink messages), or a flexible slot (e.g., a slot that may be used as downlink slot, an uplink slot, or both). In an example of a flexible slot, the network entity 105-a may transmit or output an SFI to indicate whether the slot is configured for uplink or downlink. As such, the UE 115-a may use the SFI to prioritize wireless messages 245-a during a slot based on whether the slot is indicated as uplink or downlink.

In some cases, however, the interlacing of prioritization procedures and multiplexing procedures across wireless messages 245 for a single UE 115 (e.g., intra-UE) and wireless messages 245 across multiple UEs 115 (e.g., inter-UE) may increase the complexity of the wireless communications system 200. For instance, signaling of multiple types of respective priority indicators (e.g., PI, CI, and SFI) to respective UEs 115 may increase signaling overhead of the system. Additionally, or alternatively, having multiple UEs 115 perform multiplexing may increase the energy consumption at each UE 115 while increasing latency for the network.

As such, the network entity 105-a and UEs 115 may reduce power consumption, latency, and signaling overhead associated with performing prioritization and multiplexing by operating in accordance with the techniques described herein. For example, the network entity 105-a and UEs 115 may operate in accordance with a common prioritization and multiplexing framework. Various aspects of the common prioritization and multiplexing framework are described herein.

In some cases, the common prioritization and multiplexing framework may utilize a common set of priorities across the multiple UEs 115 serviced by the network entity 105-a. For example, as illustrated in FIG. 2, the network entity 105-a may be associated with a set of global priorities 225, where each scheduled wireless message 245 may be associated with a respective global priority. For example, the scheduling messages 205 may indicate a respective global priority associated with each scheduled wireless message 245. For instance, in the example of FIG. 2, the UE 115-a may be scheduled with four wireless messages 245-a each associated with a respective global priority (e.g., P2, P3, P5, and P10) and the UE 115-b may be scheduled with four wireless messages 245-b each associated with a respective global priority (e.g., P4, P8, P11, and PN). In some examples, a lower ranked global priority is associated with a lower priority communication, and a higher ranked global priority is associated with a higher priority communication (e.g., PN is the highest priority and P1 is the lowest priority). In some other examples, a higher ranked global priority is associated with a lower priority communication, and a lower ranked global priority is associated with a higher priority communication (e.g., P1 is the highest priority and PN is the lowest priority). The examples provided in FIG. 2 may use the priority order, where P1 is the lowest priority and PN is the highest priority.

Additionally, or alternatively, each UE 115 may use a respective set of local priorities 230 (e.g., UE 115-a uses local priorities 230-a and UE 115-b uses local priorities 230-b). For example, the network entity 105-a may transmit a respective priority mapping indication 215 to each of the UEs 115, that maps the global priorities 225 to the set of local priorities 230 used by a given UE 115. For instance, the priority mapping indication 215 may indicate that the one or more wireless messages 245 are mapped from a highest local priority to a lowest local priority in accordance with a mapping between the set of global priorities 225 and the set of local priorities 230 (e.g., in accordance with a global to local priority mapping 220). For example, local priorities 230-a associated with UE 115-a may include P1, P2, P3, and P4 which may map respectively to P2, P3, P5, and P10 of the global priorities 225. Additionally, local priorities 230-b associated with UE 115-b may include P1, P2, P3, and P4, which may map respectively to P4, P8, P11, and PN of the global priorities 225. By each UE 115 using a respective set of local priorities 230, the network may reduce DCI signaling overhead used to define a local priority for each UE 115. In some examples, the priority mapping indication 215 may be an example of an RRC message.

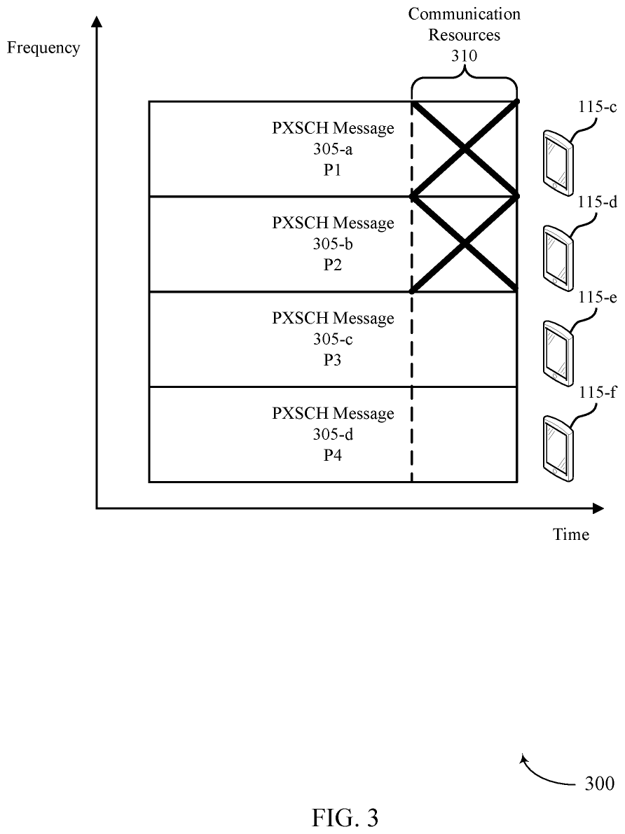

In some cases, the use of global priorities 225 and respective local priorities 230 used by each UE 115 may be used to cover the techniques of semi-static SFI, dynamic SFI, CI, and PI in accordance with inter-UE and intra-UE message prioritization. For example, the network entity 105-a may transmit a priority threshold indication 210 to each UE 115 serviced by the network entity 105-a (e.g., UE 115-a and 115-b). In some examples, the priority threshold indication 210 may be included in a GC-DCI message that the network entity 105-a transmits to a set of UEs 115 (e.g., UE 115-a and UE 115-b). In some examples, the priority threshold indication 210 may indicate a priority threshold associated with the global priorities 225 and a region of communication resources associated with the priority threshold. For instance, the priority threshold may indicate a global priority value form the set of global priorities 225, such that the priority threshold indicates to adjust a communication of any wireless messages that have a priority less than the priority threshold for the region of the communication resources. In some examples adjusting a communication may include dropping a wireless message or determining whether a flexible channel is scheduled for uplink or downlink. Further discussion of the priority threshold indication 210 is described herein, including with reference to FIG. 3.

In some cases, the use of global priorities 225 and respective local priorities 230 used by each UE 115 may be used to utilize the techniques of intra-UE multiplexing. For example, intra-UE multiplexing may be an additional UE behavior that the network entity 105-a may enable via control signaling (e.g., a DCI message). For example, the network entity 105-a may transmit to the UE 115-a a multiplexing enabling message 235, which may enable the UE 115-a to perform intra-UE multiplexing for multiple wireless messages. In some cases, the network entity 105-a may transmit the multiplexing enabling message 235 on a per UE 115 basis. That is, the network entity 105-a may transmit the multiplexing enabling message 235 via a unicast DCI to a single UE 115. In some cases, the network entity 105-a may transmit the multiplexing threshold indication 240 to multiple UEs 115. That is, the network entity 105-a may transmit the multiplexing threshold indication 240 via a CG-DCI to a set of UEs 115. In the examples of FIG. 2, the network entity 105-a transmits the multiplexing enabling message 235 to UE 115-a, such that UE 115-a may operate in accordance with intra-UE multiplexing and the UE 115-b may refrain from operating in accordance with intra-UE multiplexing.

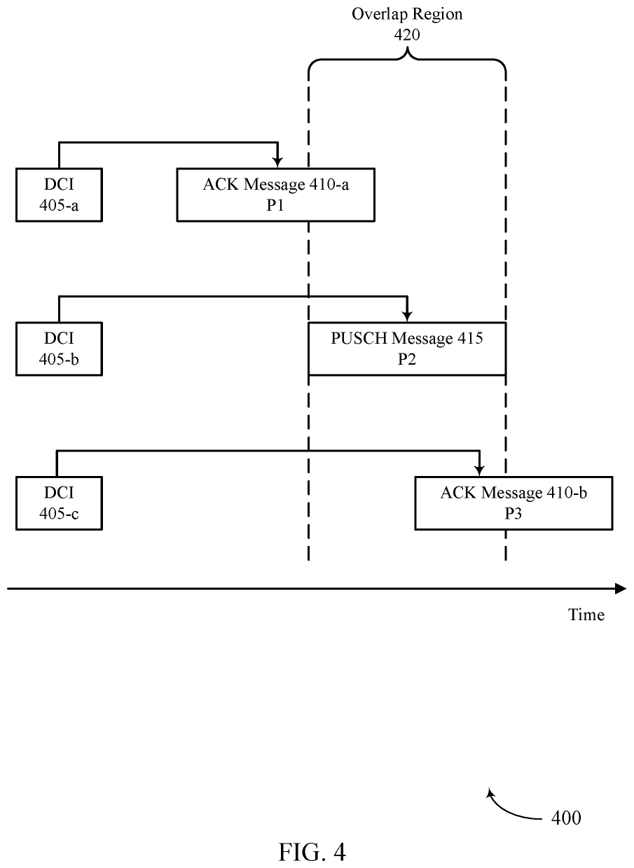

In some examples of UEs 115 enabled for intra-UE multiplexing, the network entity 105-a may indicate a multiplexing threshold indication 240. For example, the network entity 105-a may transmit to the UE 115-a a control message (e.g., a scheduling DCI message) that indicates a multiplexing threshold associated with the global priorities 225. For instance, the UE 115-a may receive from the network entity 105-a, the multiplexing threshold indication 240 which includes indication of a multiplexing threshold based on the network entity 105-a enabling the UE 115-a for intra-UE multiplexing. As such, the multiplexing threshold may indicate a global priority value from the set of global priorities 225, where the UE 115-a may compare the multiplexing threshold to the global priority indicated for each wireless message 245-a to determine which wireless messages 245-a are capable of multiplexing with other wireless messages 245-a. Further discussion of the multiplexing threshold indication 240 is described herein, including with reference to FIG. 4.

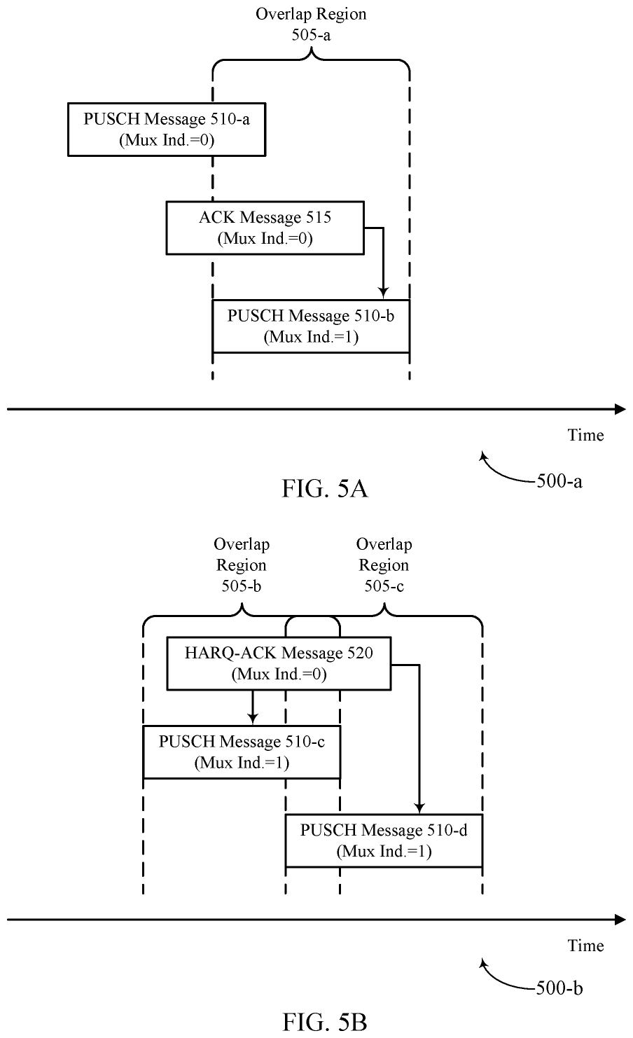

In some examples of UEs 115 enabled for intra-UE multiplexing, the network entity 105-a may indicate a respective multiplexing indicator for each scheduled wireless message 245. For instance, the scheduling message 205-a received by the UE 115-a may each indicate a respective multiplexing bit value for each wireless message 245-a. In some examples, a first value may indicate that the associated wireless message 245-a may not accept multiplexing with other wireless messages 245-a, and a second value may indicate that the associated wireless message 245-a may accept multiplexing with other wireless messages 245-a. As such, the UE 115-a may determine which wireless messages 245-a may be multiplexed together in accordance with each respective multiplexing indicator. Further discussion of the multiplexing in accordance with the respective multiplexing indicators is described herein, including with reference to FIGS. 5A and 5B.

In some cases, the UE 115-b may determine to perform multiplexing (e.g., even in cases where the UE 115-b does not receive the multiplexing enabling message 235). For examples, the network may define one or more types of messages that a given UE 115 may multiplex by default (e.g., without multiplexing enablement from the network). For instance, the UE 115-b may multiplex a semi-persistent scheduling (SPS) HARQ-ACK message on a high priority configured grant (CG) PUSCH message (e.g., a CG-PUSCH message with a priority above a threshold defined or indicated by the network).

FIG. 3 shows an example of an inter-UE message prioritization procedure 300 that supports prioritization and multiplexing framework in accordance with one or more aspects of the present disclosure. In some examples, the inter-UE message prioritization procedure 300 may implement aspects of the wireless communications system 100 and 200. For example, the inter-UE message prioritization procedure 300 may include a UE 115-c, a UE 115-d, a UE 115-e, and a UE 115-f which may be examples of UEs 115, as described with reference to FIGS. 1 and 2. Additionally, the UEs 115 of FIG. 3 may perform aspects of the inter-UE message prioritization procedure 300 in accordance with the priority threshold indication 210, as described with reference to FIG. 2.

As illustrated in FIG. 3, the UEs 115 may be each by scheduled with a respective PXSCH message 305. For example, a network entity 105 may schedule the UE 115-c, 115-d, 115-e, and 115-f with PXSCH message 305-a, 305-b, 305-c, and 305-d, respectively. In accordance with aspects of FIG. 2, the network entity 105 may schedule each of the PXSCH messages 305 by transmitting a respective scheduling message 205 to each of the UEs 115. In some examples, a given PXSCH message 305 may be an example of a PDSCH message for downlink, a PUSCH message for uplink, or an example of a message corresponding to a flexible channel that the network entity 105 may configure for uplink, for downlink, or for both. Additionally, each PXSCH message 305 may be associated with a respective priority (e.g., from the set of global priorities 225, as described with reference to FIG. 2). For example, PXSCH message 305-a has a priority value P1, PXSCH message 305-b has a priority value P2, PXSCH message 305-c has a priority value P3, and PXSCH message 305-d has a priority value P4. In the example of FIG. 3, a higher priority value (e.g., a higher P value) corresponds a higher message priority. For instance, PXSCH message 305-d may have the highest priority of the PXSCH messages 305 and PXSCH message 305-a may have the lowest priority of the PXSCH messages 305. In some other cases, however, a lower priority value (e.g., a lower P value) may correspond to a higher message priority.

As illustrated in FIG. 3, each PXSCH message 305 may be scheduled for a set of frequency resources and a set of time resources. In some cases, one or more of the PXSCH messages 305 may overlap in frequency, overlap in time, or both. For instance, in the example of FIG. 3, PXSCH message 305-a through 305-d each span a respective set of non-overlapping frequencies, and at least partially overlap across a set of time resources. Based on the PXSCH message 305-a through 305-d at least partially overlapping in time, the network entity 105 may concurrently communicate with each of UE 115-c through 115-f. In some cases, however, the network entity 105 may determine that dropping one or more of PXSCH messages 305 may be advantageous. For instance, the network entity 105 may determine to schedule another wireless message of high priority that at least partially overlaps with the PXSCH message 305. For example, the wireless message may be a URLLC message, such as an emergency services message, a public warning message, critical system signaling, a law enforcement and security message, a message for healthcare applications, a vehicle-to-everything (V2X) communication, among other examples. Additionally, or alternatively, the network entity 105 may determine to drop one or more of the PXSCH messages 305 to reduce signaling overhead of the network, to reduce latency, or both.

As such, the network entity 105 may indicate for one or more of the PXSCH messages 305 to be dropped (e.g., canceled) by transmitting a priority threshold indication (e.g., the priority threshold indication 210, as described in FIG. 2). For example, the network entity 105 may transmit a GC-DCI message that indicates each of UE 115-c through 115-f and indicates one or more of a priority threshold (e.g., S), and a region of communication resources 310. In some examples, the priority threshold may be a value associated the set of global priorities used by the network entity 105. In the example of FIG. 3, the priority threshold may be a value three (e.g., S=3) and the communication resources 310 may span a region of frequency and time resources associated with each of the PXSCH messages 305. As such, each PXSCH message 305 associated with a priority less than the priority threshold may be adjusted for the communication resources 310. For instance, the UE 115-c may determine to adjust PXSCH message 305-a based on PXSCH message 305-a having a priority value of P1 (e.g., 1<3) and the UE 115-d may determine to adjust PXSCH message 305-b based on PXSCH message 305-b having a priority value of P2 (e.g., 2<3). In some examples, adjusting a given PXSCH message 305 may include dropping the entire given PXSCH message 305 based on the given PXSCH message 305 at least partially overlapping with the communication resources 310. In some examples, adjusting a given PXSCH message 305 may include dropping a first portion of the given PXSCH message 305 that overlaps with the communication resources 310, and transmitting a second portion of the given PXSCH message 305 that does not overlap with the communication resources 310.

Additionally, or alternatively, the network entity 105 may use the priority threshold indication to configure a flexible channel as an uplink channel or a downlink channel. For instance, the PXSCH message 305-c may be associated with a flexible channel, such that the network entity 105 may configure PXSCH message 305-c as an uplink message (e.g., a PUSCH message) or a downlink message (e.g., a PDSCH message). In some examples, the network entity 105 may configure (e.g., via a scheduling control message) the flexible channel with a first priority associated with uplink and a second priority associated with downlink, where the first and second priorities may be different priorities. As such, the network entity 105 may use the priority threshold to indicate whether the flexible channel is scheduled for uplink or downlink. In a first example, the first priority associated with uplink may be a value of P2 and the second value associated with downlink may be a value of P3. In such a first example, if the CG-DCI message indicates priority threshold of S=3, then the UE 115-e may determine that the flexible channel is configured for downlink and that PXSCH message 305-c is a PDSCH message (e.g., a dynamic grant PDSCH (DG-PDSCH)). In a second example, the first priority associated with uplink may be a value of P3 and the second value associated with downlink may be a value of P2. In such a second example, if the CG-DCI message indicates priority threshold of S=3, then the UE 115-e may determine that the flexible channel is configured for uplink and that PXSCH message 305-c is PUSCH message (e.g., a dynamic grant PUSCH (DG-PUSCH)).

FIG. 4 shows an example of an intra-UE message prioritization and multiplexing procedure 400 that supports prioritization and multiplexing framework in accordance with one or more aspects of the present disclosure. In some examples, the intra-UE message prioritization and multiplexing procedure 400 may implement aspects of the wireless communications system 100 and 200. For example, one or more aspects of intra-UE message prioritization and multiplexing procedure 400 may be performed by a UE 115, as described with reference to FIGS. 1 and 2.

In some examples, the UE 115 may be scheduled with a set of wireless messages. For example, as illustrated in FIG. 4, the UE 115 is scheduled with an ACK message 410-a, a PUSCH message 415, and an ACK message 410-b, however, the UE 115 may be scheduled with any quantity and type of wireless messages. Additionally, each of the wireless messages may be scheduled by a respective DCI 405 (e.g., DCI 405-a, 405-b, and 405-c), which may be examples of scheduling messages 205, as described with reference to FIG. 2. In some examples, each of the DCIs 405 may indicate a respective priority value corresponding to the wireless message a given DCI 405 is scheduling. For instance, DCI 405-a may indicate a priority value of P1 for ACK message 410-a, DCI 405-b may indicate a priority value of P2 for PUSCH message 415, and DCI 405-c may indicate a priority value of P3 for ACK message 410-a. With reference to FIG. 4, a higher priority value (e.g., a higher P value) corresponds a higher message priority. That is, ACK message 410-b may be associated with a highest message priority and ACK message 410-a may be associate with a lowest message priority. In some other cases, however, a lower priority value (e.g., a lower P value) corresponds a higher message priority.

As illustrated in FIG. 4, one or more of the wireless messages may be scheduled for time and frequency resources that at least partially overlap. For instance, PUSCH message 415 may be associated with an overlap region 420, where a first subset of time resources of PUSCH message 415 overlaps in time with ACK message 410-a and a second subset of time resources of PUSCH message 415 overlaps in time with the ACK message 410-b.

In some cases, the UE 115 may operate in accordance with one or more intra-UE message prioritization techniques based on the PUSCH message 415 being associated with the overlap region 420.

In a first example, the UE 115 may perform a first prioritization procedure where the UE 115 may start from the highest priority wireless message and drop any wireless messages that overlap with the highest priority wireless message. For instance, the UE 115 may start with ACK message 410-b and identify that PUSCH message 415 at least partially overlaps in time with ACK message 410-b, and as such, the UE 115 may drop PUSCH message 415. In accordance with the first prioritization procedure, the UE 115 may proceed to the subsequent wireless message associated with a second highest message priority. For instance, the UE 115 may analyze ACK message 410-a and identify that no other wireless messages overlap in time with the ACK message 410-a (e.g., based on the UE 115 previously dropping PUSCH message 415). In some examples, the UE 115 may stop the first prioritization procedure after analyzing the wireless message associated with the lowest priority level of the scheduled wireless messages. As such, the UE 115 may determine to drop PUSCH message 415 and transmit ACK message 410-a and ACK message 410-b in accordance with performing the first prioritization procedure.

In a second example, the UE 115 may perform a second prioritization procedure where the UE 115 may start from the lowest priority wireless message and drop the lowest priority wireless message if any higher priority wireless message overlap in time. For instance, the UE 115 may start with ACK message 410-a and identify that PUSCH message 415 at least partially overlaps in time with ACK message 410-a, and as such, the UE 115 may drop ACK message 410-a. In accordance with the second prioritization procedure, the UE 115 may proceed to a subsequent wireless message associated with a second lowest message priority. For instance, the UE 115 may analyze PUSCH message 415 and identify that ACK message 410-b at least partially overlaps in time with PUSCH message 415, and as such, the UE 115 may drop PUSCH message 415. In some examples, the UE 115 may stop the second prioritization procedure after analyzing the wireless message associated with the highest priority level of the scheduled wireless messages. As such, the UE 115 may determine to drop ACK message 410-a and PUSCH message 415 and ACK message 410-b in accordance with performing the second prioritization procedure.

In some cases, the UE 115 may operate in accordance with one or more intra-UE message multiplexing techniques based on the PUSCH message 415 being associated with the overlap region 420. In some examples, the UE 115 may perform the intra-UE message multiplexing based on the UE 115 receiving the multiplexing enabling message 235, as described with reference to FIG. 2. In some examples of intra-UE multiplexing, the UE 115 may operate in accordance with a multiplexing threshold. For instance, the UE 115 may receive the multiplexing threshold indication 240, as described with reference to FIG. 2. As such, FIG. 4 may describe one or more examples of the UE 115 operating in accordance with the indicated multiplexing threshold (e.g., an integer value of M).

In some examples, the value of the multiplexing threshold may be associated with the set of global priorities 225, as described with reference to FIG. 2. As such, the UE 115 may compare the value of the multiplexing threshold to the priority of each wireless message to determine which wireless messages are capable of multiplexing. In examples where M>0, the UE 115 may multiplex colliding wireless messages with a priority that is greater than or equal to the multiplexing threshold and drop any wireless messages with a priority less than the multiplexing threshold. For instance, if M=1, then the UE 115 may determine to multiplex both ACK message 410-a and ACK message 410-b with the PUSCH message 415. If M=2 or M=3, then the UE 115 may determine to multiplex ACK message 410-b with the PUSCH message 415 and drop ACK message 410-a. In cases where M is greater than each priority of the scheduled wireless messages (e.g., M>4), then the UE 115 may determine refrain from performing multiplexing and operate in accordance with one or more of the intra-UE prioritization procedures described herein.

FIGS. 5A and 5B show respective examples of intra-UE message multiplexing procedure 500-a and 500-b that supports prioritization and multiplexing framework in accordance with one or more aspects of the present disclosure. In some examples, intra-UE message multiplexing procedure 500-a and 500-b may implement aspects of the wireless communications system 100 and 200. For example, one or more aspects of intra-UE message multiplexing procedure 500 may be performed by a UE 115, as described with reference to FIGS. 1 and 2.

As illustrated in FIGS. 5A and 5B, the UE 115 may be scheduled with a set of wireless messages. For example, in FIG. 5A, the UE 115 is scheduled with PUSCH message 510-a, ACK message 515, and PUSCH message 510-b. In FIG. 5B, the UE 115 is scheduled with HARQ-ACK message 520, PUSCH message 510-c, and PUSCH message 510-d. Additionally, each of the wireless messages may be scheduled by one or more scheduling messages 205, as described in FIG. 2. Additionally, the one or more scheduling messages 205 may indicate a respective priority value corresponding to each of the wireless messages (e.g., which may follow similar priority schemes discussed with reference to FIGS. 2 through 4).

In some cases, the UE 115 may operate in accordance with intra-UE message multiplexing procedure 500-a or 500-b based on the UE 115 receiving the multiplexing enabling message 235, as described with reference to FIG. 2. In such cases, the one or more scheduling messages 205 may additionally indicate a respective multiplexing indicator associated with each wireless message (e.g., the multiplexing indicator can be indicated via an uplink grant or a downlink grant). As such, the UE may use each multiplexing indicator to determine whether an associated wireless message may be multiplexed. For instance, if a given wireless message is associated with a first value of the multiplexing indicator the UE may refrain from multiplexing additional wireless messages on the frequency channel associated with the given wireless message. If a given wireless message is associated with a second value of the multiplexing indicator the UE may allow multiplexing of additional wireless messages on the frequency channel associated with the given wireless message. In the examples described in FIGS. 5A and 5B, a bit value of ‘0’ may correspond to the first value and a bit value of ‘1’ may correspond to the second value. However, in other examples a bit value of ‘1’ may correspond to the first value and a bit value of ‘0’ may correspond to the second value.

As illustrated in FIG. 5A, one or more of the wireless messages may be scheduled for time and frequency resources that at least partially overlap. For instance, PUSCH message 510-b may be associated with an overlap region 505-a during which the PUSCH message 510-a and the ACK message 515 may at least partially overlap in time with the PUSCH message 510-b. As such, the UE may determine which wireless messages to multiplex or drop in accordance with the multiplexing indicator associated with each of the wireless messages. For instance, PUSCH message 510-b is associated with multiplexing indicator of 1 and bother PUSCH message 510-a and ACK message 515 are associated with a multiplexing indicator of 0. As such, the UE may multiplex the ACK message 515 with PUSCH message 510-b using with frequency channel associated with the PUSCH message 510-b. In some examples, the UE may refrain, however, from multiplexing multiple PUSCH messages on a same frequency channel. For instance, based on the PUSCH message 510-a at least partially overlapping with PUSCH message 510-b, the UE may determine to drop PUSCH message 510-a, based on the PUSCH message 510-a being associated with multiplexing indicator of 0.

As illustrated in FIG. 5B, one or more of the wireless messages may be scheduled for time and frequency resources that at least partially overlap. For instance, PUSCH message 510-c may be associated with an overlap region 505-b and PUSCH message 510-d may be associated with an overlap region 505-c, where HARQ-ACK message 520 may be scheduled for time resources associated with both overlap region 505-b and 505-c. As such, the UE may determine which wireless messages to multiplex or drop in accordance with the multiplexing indicator associated with each of the wireless messages. For instance, both PUSCH message 510-c and 510-d are associated with a multiplexing indicator of 1 and HARQ-ACK message 520 is associated with a multiplexing indicator of 0. As such, the UE may multiplex the HARQ-ACK message 520 with PUSCH message 510-c using the frequency channel associated with the PUSCH message 510-c or with PUSCH message 510-d using the frequency channel associated with the PUSCH message 510-d. Additionally, or alternatively, the UE may determine to duplicate (e.g., copy) the HARQ-ACK message 520 and multiplex the HARQ-ACK message 520 on both PUSCH message 510-c using the frequency channel associated with the PUSCH message 510-c and with PUSCH message 510-d using the frequency channel associated with the PUSCH message 510-d.

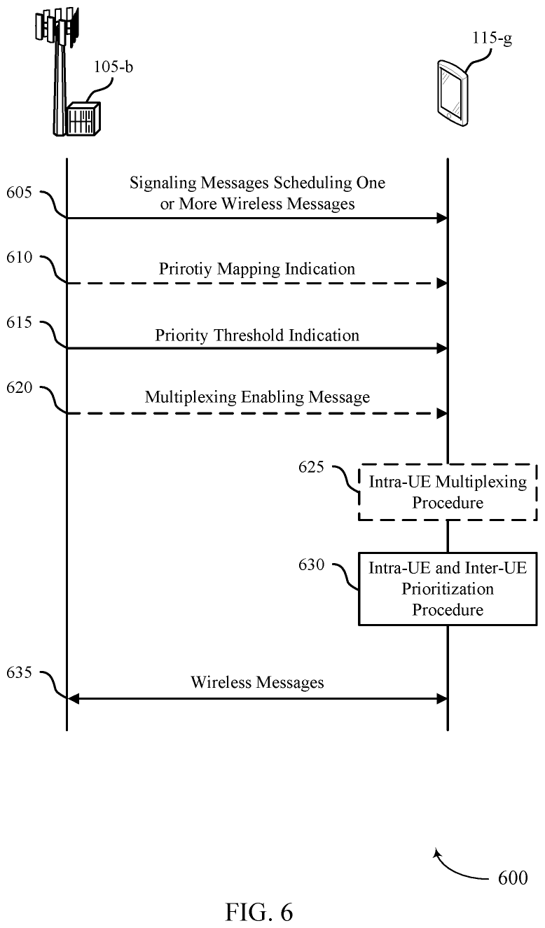

FIG. 6 shows an example of a process flow 600 that supports prioritization and multiplexing framework in accordance with one or more aspects of the present disclosure. In some examples, process flow 600 may implement aspects of wireless communications system 100 wireless communications system 200, inter-UE message prioritization procedure 300, inter-UE message prioritization and multiplexing procedure 400, and intra-UE message multiplexing procedure 500-a and 500-b. Process flow 600 includes a UE 115-g and a network entity 105-b as described with reference to FIGS. 1 through 5. Alternative examples of the following may be implemented, where some steps are performed in a different order than described or are not performed at all. In some cases, steps may include additional features not mentioned below, or further steps may be added. In addition, these processes may occur between any quantity of network devices and network device types. For instance, the network entity 105-b may communicate one or more signals referenced herein to multiple of UEs 115.

At 605, the UE 115-g may receive one or more first signaling messages that schedule one or more wireless messages. For instance, the network entity 105-b may schedule the UE 115-g with one or more uplink messages, one or more downlink messages, or a combination thereof. In some examples, the one or more first signaling messages may indicate a respective priority associated with each wireless message of the one or more wireless messages (e.g., a respective global priority from the set of global priorities 225).

In some examples, at 610, the UE 115-g may receive an RRC message that maps a set of global priorities to a set of local priorities used by the UE 115-g (e.g., local priorities 230). In some examples, the one or more wireless messages are mapped from a highest local priority to a lowest local priority in accordance with a mapping between the set of global priorities and the set of local priorities. In some examples, a first quantity of local priorities used by the UE 115-g is less than a second quantity of global priorities configured by the network entity 105-b.

At 615, the UE 115-g may receive a second signaling message that indicates a priority threshold. For example, the second signaling message may indicate for the UE 115-g to adjust a communication of any scheduled wireless messages that have a priority less than the priority threshold. In some examples, the second signaling message may be a GC-DCI message that is associated with multiple UEs115 including the UE 115-g. That is, the network entity may output the second signaling message that indicates a priority threshold to multiple UEs 115 serviced by the network entity 105-b.

In some examples, at 620, the UE 115-g may optionally receive a third signaling message that enables multiplexing across multiple wireless messages transmitted by the UE 115-g. For instance, the third signaling message may indicate for the UE 115-g to perform inter-UE multiplexing for one or more scheduled uplink messages. In some examples, the network entity 105-b may enable multiplexing on a per UE 115-g basis. That is, the network entity 105-b may enable a first serviced UE 115 to perform multiplexing and refrain from enabling a second serviced UE 115 from performing multiplexing.

If the UE 115-g is enabled to perform multiplexing, then at 625, the UE 115-g may perform an inter-UE multiplexing procedure.

In some examples of multiplexing, the UE 115-g may receive a scheduling DCI message (e.g., as part of the one or more first signaling messages, at 605) that schedules a first wireless message of the one or more wireless messages and indicates a multiplexing threshold for the first wireless message. In such examples, the scheduling DCI message may indicate for the UE 115-g to adjust the communication of the one or more wireless messages in accordance with the multiplexing threshold. For instance, adjusting the communication may include dropping any wireless messages that at least partially overlap in time with the first wireless message and are associated with a priority that is less than the multiplexing threshold, and multiplexing wireless messages that at least partially overlap in time with the first wireless message and are associated with respective priorities that are greater than or equal to the multiplexing threshold.

In some examples of multiplexing, the UE 115-g may receive, as part of the one or more first signaling messages, a respective multiplexing indicator associated with each wireless message of the one or more wireless messages. In some examples, a respective multiplexing indicator may indicate whether an associated wireless message is configured for multiplexing with other wireless messages. For example, the UE 115-g may multiplex a first wireless message with a second wireless message based on the second wireless message being associated with a respective multiplexing indicator that indicates that the second wireless message is configured for multiplexing (e.g., the UE 115-g may multiplex additional messages on the channel associated with the second wireless message). Additionally, or alternatively, the UE 115-g may copy a given wireless message and multiplex it with multiple other messages. For instance, the UE 115-g may further multiplex the first wireless message with a third wireless message based on the third wireless message being associated with a respective multiplexing indicator that indicates that the third wireless message is configured for multiplexing. In some examples, the UE 115-g may refrain from multiplexing a first PUSCH message with a second PUSCH message (e.g., even if both the first and second PUSCH message allow for multiplexing).

Additionally, or alternatively, at 630, the UE 115-g may perform an inter-UE prioritization procedure, inter-UE prioritization procedure, or both.

In some examples, the inter-UE prioritization procedure may include one or more techniques described with reference to FIG. 4. For instance, the UE 115-g may drop a first wireless message that is associated with a first priority based on the first wireless message at least partially overlapping in time with a second wireless message of the one or more wireless messages that is associated with associated with a second priority greater than the first priority.

In some examples, the inter-UE prioritization procedure may include one or more techniques described with reference to FIG. 3. For instance, the second signaling message (at 615) may further indicate a region of communication resources. As such, the UE 115-g may drop, for the region of the communication resources, a subset of wireless messages of the one or more wireless messages based on each of the subset of wireless messages being associated with respective priorities that are less than the priority threshold. In some examples, the region of the communication resources may include a set of time resources and a set of frequency resources.

In some examples, the priority threshold indication may further indicate a type of channel associated with a flexible channel. For instance, the UE 115-g may receive a signaling message of the one or more first signaling messages that configures a flexible channel, where the flexible channel is configurable as an uplink channel associated with a first priority or a downlink channel associated with a second priority. In some examples, one of the first priority and the second priority is greater than or equal to the priority threshold. As such, the UE 115-g may determine that the flexible channel is the uplink channel or the downlink channel in accordance with which one of the first priority and the second priority is greater than or equal to the priority threshold.

At 635, the UE 115-g may communicate at least a portion of the one or more wireless messages based on the performing one of the inter-UE multiplexing procedure, the inter-UE prioritization procedure, the inter-UE prioritization procedure, or a combination thereof.

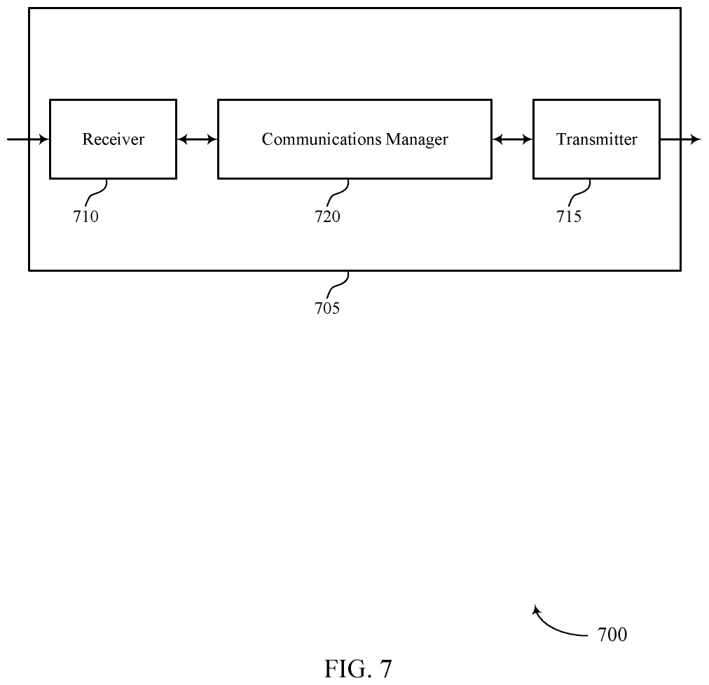

FIG. 7 shows a block diagram 700 of a device 705 that supports prioritization and multiplexing framework in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to prioritization and multiplexing framework). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to prioritization and multiplexing framework). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of prioritization and multiplexing framework as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving one or more first signaling messages that schedule one or more wireless messages, the one or more first signaling messages indicating a respective priority associated with each wireless message of the one or more wireless messages. The communications manager 720 is capable of, configured to, or operable to support a means for receiving a second signaling message that indicates a priority threshold, where the second signaling message indicates for the UE to adjust a communication of any wireless messages that have a priority less than the priority threshold. The communications manager 720 is capable of, configured to, or operable to support a means for communicating at least a portion of the one or more wireless messages based on the priority threshold.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and a more efficient utilization of communication resources.

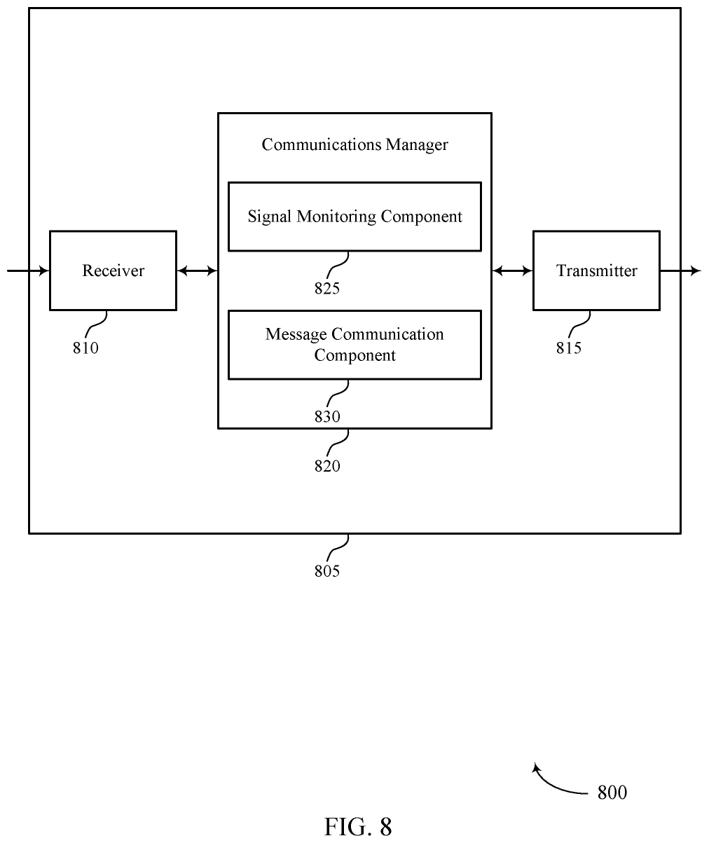

FIG. 8 shows a block diagram 800 of a device 805 that supports prioritization and multiplexing framework in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to prioritization and multiplexing framework). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to prioritization and multiplexing framework). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of prioritization and multiplexing framework as described herein. For example, the communications manager 820 may include a signal monitoring component 825 a message communication component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The signal monitoring component 825 is capable of, configured to, or operable to support a means for receiving one or more first signaling messages that schedule one or more wireless messages, the one or more first signaling messages indicating a respective priority associated with each wireless message of the one or more wireless messages. The signal monitoring component 825 is capable of, configured to, or operable to support a means for receiving a second signaling message that indicates a priority threshold, where the second signaling message indicates for the UE to adjust a communication of any wireless messages that have a priority less than the priority threshold. The message communication component 830 is capable of, configured to, or operable to support a means for communicating at least a portion of the one or more wireless messages based on the priority threshold.

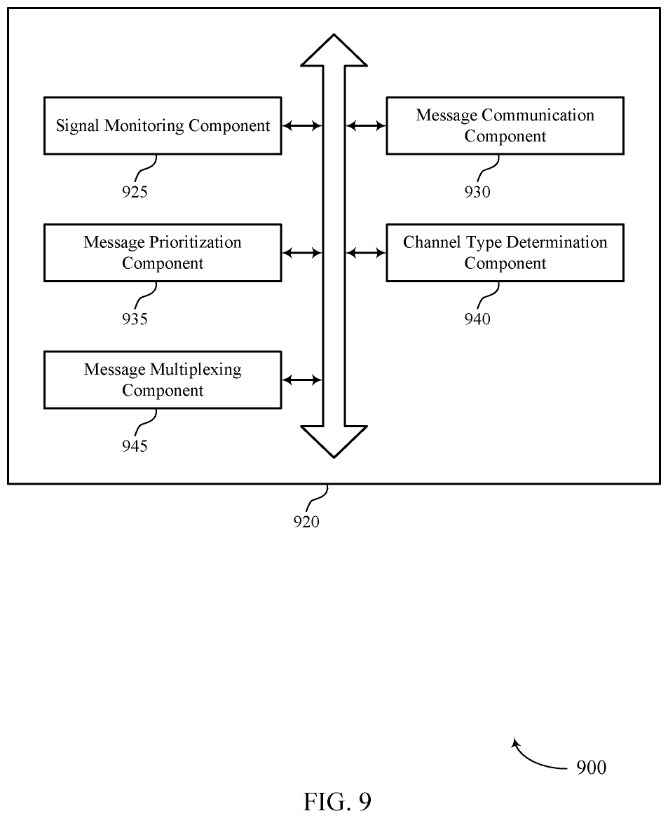

FIG. 9 shows a block diagram 900 of a communications manager 920 that supports prioritization and multiplexing framework in accordance with one or more aspects of the present disclosure. The communications manager 920 may be an example of aspects of a communications manager 720, a communications manager 820, or both, as described herein. The communications manager 920, or various components thereof, may be an example of means for performing various aspects of prioritization and multiplexing framework as described herein. For example, the communications manager 920 may include a signal monitoring component 925, a message communication component 930, a message prioritization component 935, a channel type determination component 940, a message multiplexing component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The signal monitoring component 925 is capable of, configured to, or operable to support a means for receiving one or more first signaling messages that schedule one or more wireless messages, the one or more first signaling messages indicating a respective priority associated with each wireless message of the one or more wireless messages. In some examples, the signal monitoring component 925 is capable of, configured to, or operable to support a means for receiving a second signaling message that indicates a priority threshold, where the second signaling message indicates for the UE to adjust a communication of any wireless messages that have a priority less than the priority threshold. The message communication component 930 is capable of, configured to, or operable to support a means for communicating at least a portion of the one or more wireless messages based on the priority threshold.

In some examples, the signal monitoring component 925 is capable of, configured to, or operable to support a means for receiving a RRC message that maps a set of global priorities to a set of local priorities used by the UE, where the one or more wireless messages are mapped from a highest local priority to a lowest local priority in accordance with a mapping between the set of global priorities and the set of local priorities.

In some examples, a first quantity of local priorities used by the UE is less than a second quantity of global priorities configured by a network entity.

In some examples, the second signaling message further indicates a region of communication resources, and the message prioritization component 935 is capable of, configured to, or operable to support a means for dropping, for the region of the communication resources, a subset of wireless messages of the one or more wireless messages based on each wireless message of the subset of wireless messages being associated with respective priorities that are less than the priority threshold, where communicating at least the portion of the one or more wireless messages is based on the dropping.

In some examples, the region of the communication resources includes a set of time resources and a set of frequency resources.

In some examples, the signal monitoring component 925 is capable of, configured to, or operable to support a means for receiving a signaling message of the one or more first signaling messages that configures a flexible channel, where the flexible channel is configurable as an uplink channel associated with a first priority or a downlink channel associated with a second priority, and where one of the first priority and the second priority is greater than or equal to the priority threshold. In some examples, the channel type determination component 940 is capable of, configured to, or operable to support a means for determining that the flexible channel is the uplink channel or the downlink channel in accordance with which one of the first priority and the second priority is greater than or equal to the priority threshold, where communicating at least the portion of the one or more wireless messages is based on the determining.

In some examples, to support communicating at least the portion of the one or more wireless messages, the message prioritization component 935 is capable of, configured to, or operable to support a means for dropping a first wireless message of the one or more wireless messages that is associated with a first priority based on the first wireless message at least partially overlapping in time with a second wireless message of the one or more wireless messages that is associated with associated with a second priority greater than the first priority.

In some examples, the signal monitoring component 925 is capable of, configured to, or operable to support a means for receiving a third signaling message that enables multiplexing across multiple wireless messages transmitted by the UE.

In some examples, the signal monitoring component 925 is capable of, configured to, or operable to support a means for receiving a scheduling DCI message that schedules a first wireless message of the one or more wireless messages and indicates a multiplexing threshold for the first wireless message, where receiving the scheduling DCI message indicates for the UE to adjust the communication of the one or more wireless messages in accordance with the multiplexing threshold.

In some examples, to support adjusting the communication of the one or more wireless messages in accordance with the multiplexing threshold, the message prioritization component 935 is capable of, configured to, or operable to support a means for dropping any wireless messages that at least partially overlap in time with the first wireless message and are associated with a priority that is less than the multiplexing threshold. In some examples, to support adjusting the communication of the one or more wireless messages in accordance with the multiplexing threshold, the message multiplexing component 945 is capable of, configured to, or operable to support a means for multiplexing wireless messages that at least partially overlap in time with the first wireless message and are associated with respective priorities that are greater than or equal to the multiplexing threshold.

In some examples, the signal monitoring component 925 is capable of, configured to, or operable to support a means for receiving, as part of the one or more first signaling messages, a respective multiplexing indicator associated with each wireless message of the one or more wireless messages, where the respective multiplexing indicator indicates whether an associated wireless message is configured for multiplexing with other wireless messages.

In some examples, the message multiplexing component 945 is capable of, configured to, or operable to support a means for multiplexing a first wireless message of the one or more wireless messages with a second wireless message of the one or more wireless messages based on the second wireless message being associated with a respective multiplexing indicator that indicates that the second wireless message is configured for multiplexing.

In some examples, the message multiplexing component 945 is capable of, configured to, or operable to support a means for multiplexing the first wireless message with a third wireless message of the one or more wireless messages based on the third wireless message being associated with a respective multiplexing indicator that indicates that the third wireless message is configured for multiplexing.

In some examples, the second signaling message is a GC-DCI message that is associated with a set of multiple UEs including the UE.

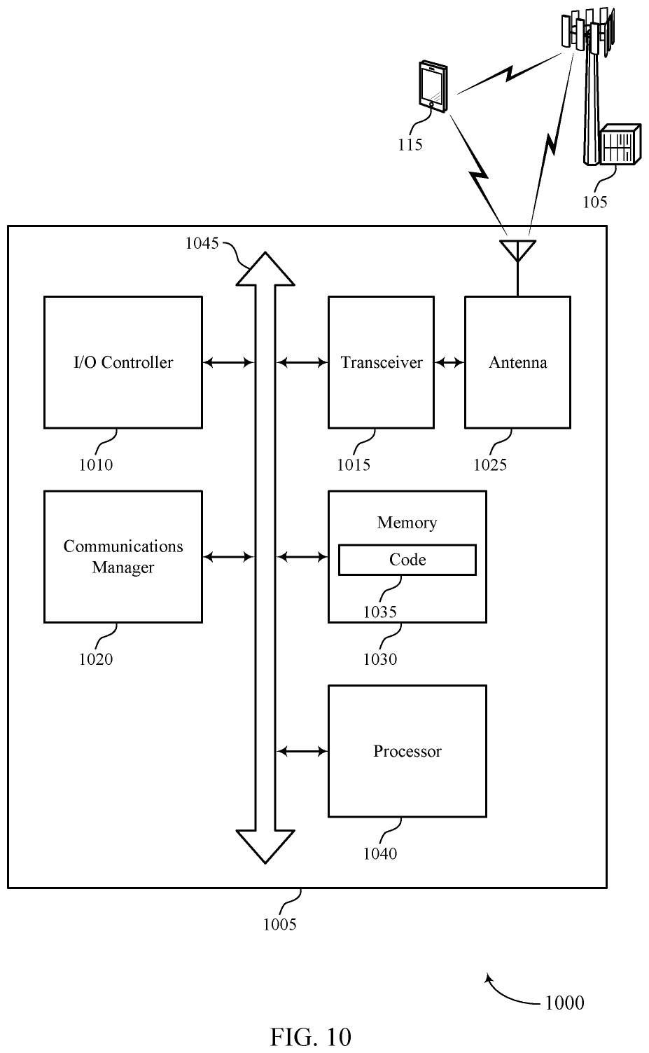

FIG. 10 shows a diagram of a system 1000 including a device 1005 that supports prioritization and multiplexing framework in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting prioritization and multiplexing framework). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving one or more first signaling messages that schedule one or more wireless messages, the one or more first signaling messages indicating a respective priority associated with each wireless message of the one or more wireless messages. The communications manager 1020 is capable of, configured to, or operable to support a means for receiving a second signaling message that indicates a priority threshold, where the second signaling message indicates for the UE to adjust a communication of any wireless messages that have a priority less than the priority threshold. The communications manager 1020 is capable of, configured to, or operable to support a means for communicating at least a portion of the one or more wireless messages based on the priority threshold.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, and an improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of prioritization and multiplexing framework as described herein, or the at least one processor 1040 and the at least one memory 1030 may be otherwise configured to, individually or collectively, perform or support such operations.

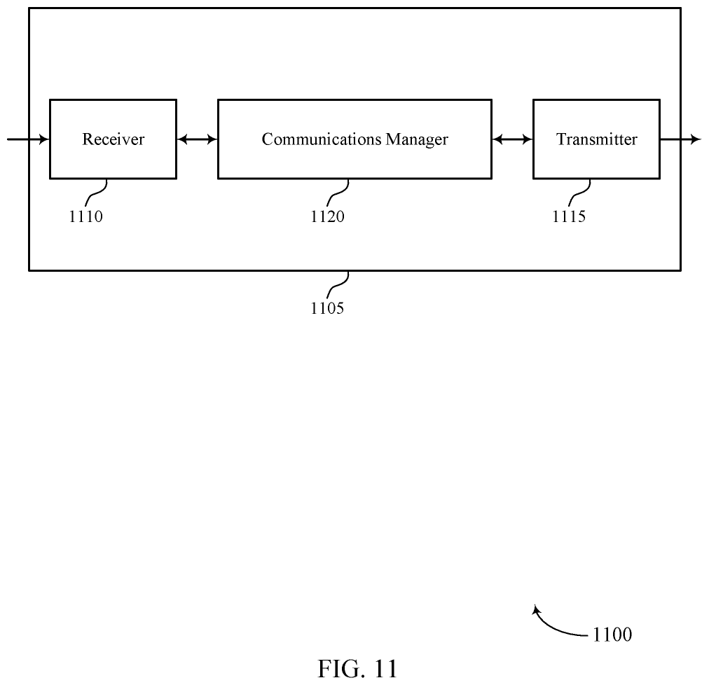

FIG. 11 shows a block diagram 1100 of a device 1105 that supports prioritization and multiplexing framework in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of prioritization and multiplexing framework as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting, to a set of multiple user equipments (UEs), one or more first signaling messages that schedule respective one or more wireless messages for each UE of the set of multiple UEs, the one or more first signaling messages indicating a respective priority associated with each wireless message of the respective one or more wireless messages. The communications manager 1120 is capable of, configured to, or operable to support a means for outputting, to the set of multiple UEs, a second signaling message that indicates a priority threshold, where outputting the second signaling message indicates for the set of multiple UEs to adjust a communication of any wireless messages that have a priority less than the priority threshold. The communications manager 1120 is capable of, configured to, or operable to support a means for communicating, with the set of multiple UEs, at least a portion of the respective one or more wireless messages based on the priority threshold.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and a more efficient utilization of communication resources.

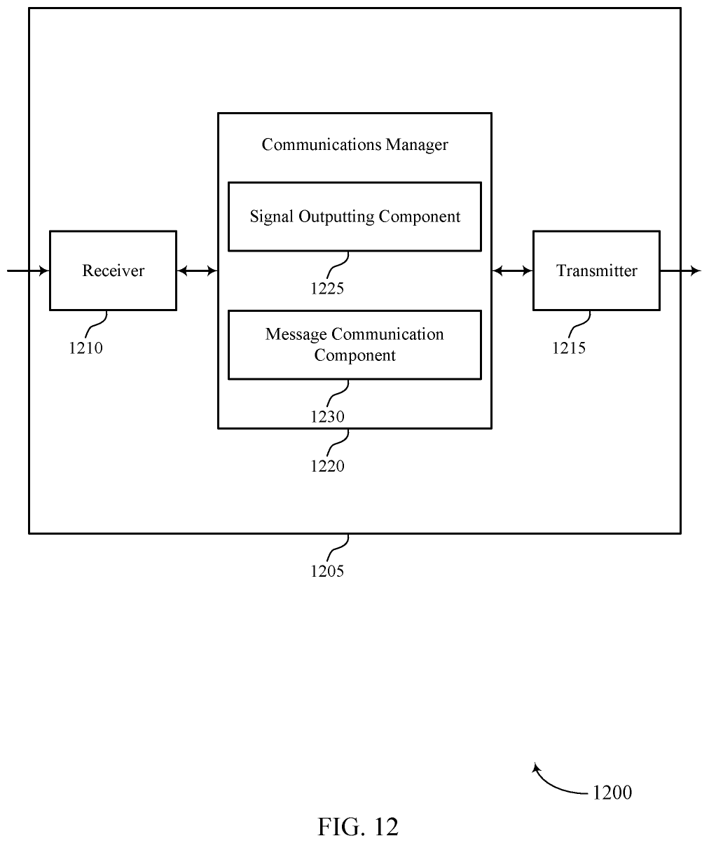

FIG. 12 shows a block diagram 1200 of a device 1205 that supports prioritization and multiplexing framework in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of prioritization and multiplexing framework as described herein. For example, the communications manager 1220 may include a signal outputting component 1225 a message communication component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The signal outputting component 1225 is capable of, configured to, or operable to support a means for outputting, to a set of multiple user equipments (UEs), one or more first signaling messages that schedule respective one or more wireless messages for each UE of the set of multiple UEs, the one or more first signaling messages indicating a respective priority associated with each wireless message of the respective one or more wireless messages. The signal outputting component 1225 is capable of, configured to, or operable to support a means for outputting, to the set of multiple UEs, a second signaling message that indicates a priority threshold, where outputting the second signaling message indicates for the set of multiple UEs to adjust a communication of any wireless messages that have a priority less than the priority threshold. The message communication component 1230 is capable of, configured to, or operable to support a means for communicating, with the set of multiple UEs, at least a portion of the respective one or more wireless messages based on the priority threshold.

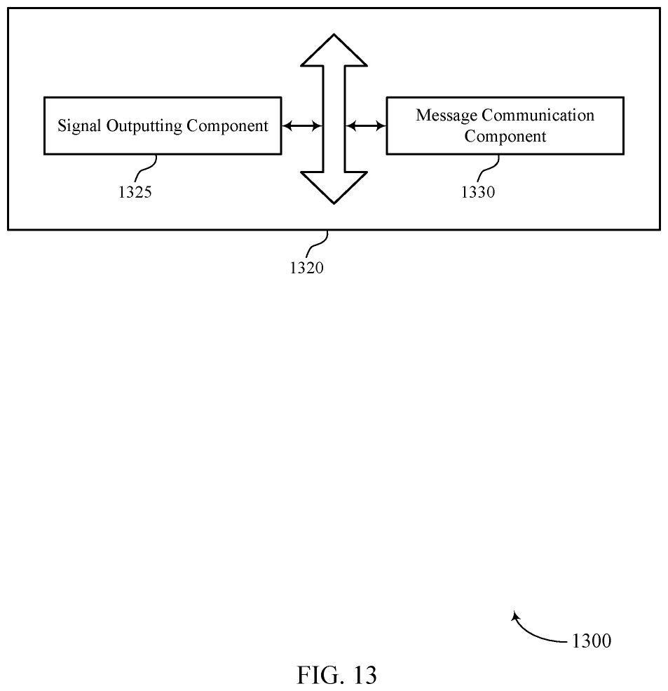

FIG. 13 shows a block diagram 1300 of a communications manager 1320 that supports prioritization and multiplexing framework in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of prioritization and multiplexing framework as described herein. For example, the communications manager 1320 may include a signal outputting component 1325 a message communication component 1330, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The signal outputting component 1325 is capable of, configured to, or operable to support a means for outputting, to a set of multiple user equipments (UEs), one or more first signaling messages that schedule respective one or more wireless messages for each UE of the set of multiple UEs, the one or more first signaling messages indicating a respective priority associated with each wireless message of the respective one or more wireless messages. In some examples, the signal outputting component 1325 is capable of, configured to, or operable to support a means for outputting, to the set of multiple UEs, a second signaling message that indicates a priority threshold, where outputting the second signaling message indicates for the set of multiple UEs to adjust a communication of any wireless messages that have a priority less than the priority threshold. The message communication component 1330 is capable of, configured to, or operable to support a means for communicating, with the set of multiple UEs, at least a portion of the respective one or more wireless messages based on the priority threshold.

In some examples, the signal outputting component 1325 is capable of, configured to, or operable to support a means for outputting, to each UE of the set of multiple UEs, a respective RRC message that maps a set of global priorities to a respective set of local priorities used by a respective UE of the set of multiple UEs, where the respective one or more wireless messages for the respective UE are mapped from a highest local priority to a lowest local priority in accordance with a mapping between the set of global priorities and the respective set of local priorities.

In some examples, the second signaling message indicates for the set of multiple UEs to drop wireless messages associated with respective priorities that are less than the priority threshold.

In some examples, the signal outputting component 1325 is capable of, configured to, or operable to support a means for outputting, to a first UE of the set of multiple UEs, a signaling message of the one or more first signaling messages that configures a flexible channel, where the flexible channel is configurable as an uplink channel associated with a first priority or a downlink channel associated with a second priority, and where one of the first priority and the second priority is greater than or equal to the priority threshold. In some examples, the signal outputting component 1325 is capable of, configured to, or operable to support a means for scheduling the flexible channel as the uplink channel or the downlink channel in accordance with which one of the first priority and the second priority is greater than or equal to the priority threshold, where communicating at least the portion of the respective one or more wireless messages is based on the scheduling.

In some examples, the signal outputting component 1325 is capable of, configured to, or operable to support a means for outputting, to a first UE of the set of multiple UEs, a third signaling message that enables multiplexing across multiple wireless messages outputted by the first UE.

In some examples, the signal outputting component 1325 is capable of, configured to, or operable to support a means for outputting, to the first UE, a scheduling DCI message that schedules a first wireless message of the respective one or more wireless messages and indicates a multiplexing threshold for the first wireless message, where outputting the scheduling DCI message indicates for the first UE to adjust the communication of the respective one or more wireless messages in accordance with the multiplexing threshold.

In some examples, the multiplexing threshold indicates for the first UE to drop any wireless messages that at least partially overlap in time with the first wireless message and are associated with a priority that is less than the multiplexing threshold, and to multiplex any wireless messages that at least partially overlap in time with the first wireless message and are associated with respective priorities that are greater than or equal to the multiplexing threshold.

In some examples, the signal outputting component 1325 is capable of, configured to, or operable to support a means for outputting, as part of the one or more first signaling messages, a respective multiplexing indicator associated with each wireless message of the respective one or more wireless messages associated with the first UE, where the respective multiplexing indicator indicates whether an associated wireless message is configured for multiplexing with other wireless messages.

In some examples, the second signaling message is a GC-DCI message that is associated with the set of multiple UEs.

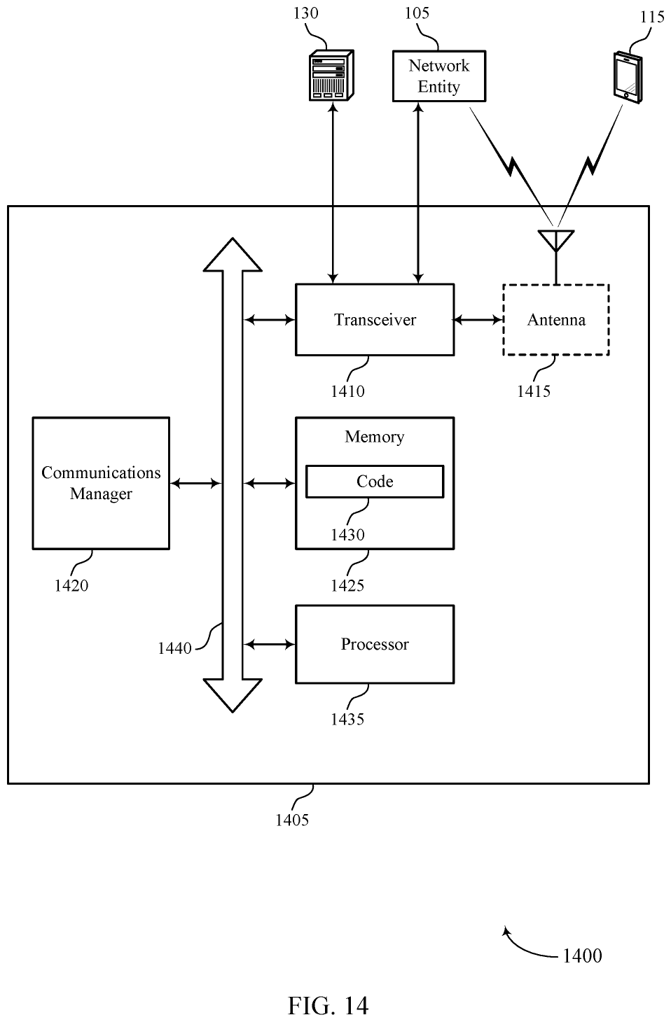

FIG. 14 shows a diagram of a system 1400 including a device 1405 that supports prioritization and multiplexing framework in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting prioritization and multiplexing framework). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting, to a set of multiple user equipments (UEs), one or more first signaling messages that schedule respective one or more wireless messages for each UE of the set of multiple UEs, the one or more first signaling messages indicating a respective priority associated with each wireless message of the respective one or more wireless messages. The communications manager 1420 is capable of, configured to, or operable to support a means for outputting, to the set of multiple UEs, a second signaling message that indicates a priority threshold, where outputting the second signaling message indicates for the set of multiple UEs to adjust a communication of any wireless messages that have a priority less than the priority threshold. The communications manager 1420 is capable of, configured to, or operable to support a means for communicating, with the set of multiple UEs, at least a portion of the respective one or more wireless messages based on the priority threshold.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, and an improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of prioritization and multiplexing framework as described herein, or the at least one processor 1435 and the at least one memory 1425 may be otherwise configured to, individually or collectively, perform or support such operations.

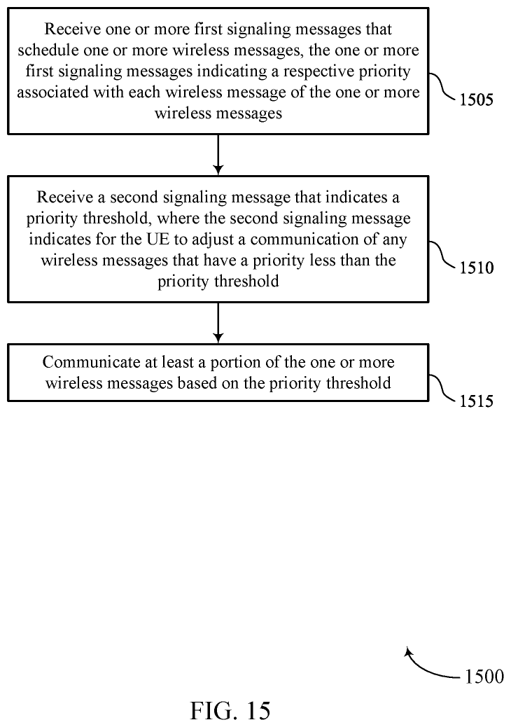

FIG. 15 shows a flowchart illustrating a method 1500 that supports prioritization and multiplexing framework in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving one or more first signaling messages that schedule one or more wireless messages, the one or more first signaling messages indicating a respective priority associated with each wireless message of the one or more wireless messages. The operations of block 1505 may be performed in accordance with examples as disclosed herein. In some examples, aspects of the operations of 1505 may be performed by a signal monitoring component 925 as described with reference to FIG. 9.

At 1510, the method may include receiving a second signaling message that indicates a priority threshold, where the second signaling message indicates for the UE to adjust a communication of any wireless messages that have a priority less than the priority threshold. The operations of block 1510 may be performed in accordance with examples as disclosed herein. In some examples, aspects of the operations of 1510 may be performed by a signal monitoring component 925 as described with reference to FIG. 9.

At 1515, the method may include communicating at least a portion of the one or more wireless messages based on the priority threshold. The operations of block 1515 may be performed in accordance with examples as disclosed herein. In some examples, aspects of the operations of 1515 may be performed by a message communication component 930 as described with reference to FIG. 9.

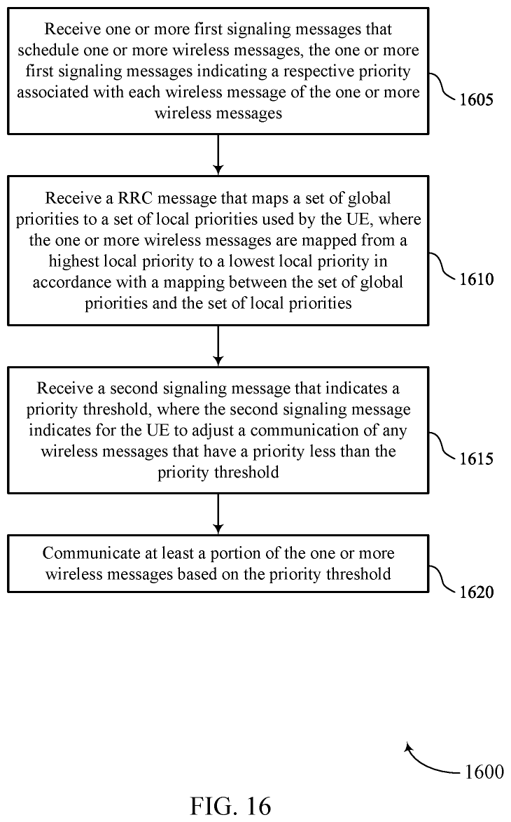

FIG. 16 shows a flowchart illustrating a method 1600 that supports prioritization and multiplexing framework in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving one or more first signaling messages that schedule one or more wireless messages, the one or more first signaling messages indicating a respective priority associated with each wireless message of the one or more wireless messages. The operations of block 1605 may be performed in accordance with examples as disclosed herein. In some examples, aspects of the operations of 1605 may be performed by a signal monitoring component 925 as described with reference to FIG. 9.

At 1610, the method may include receiving a RRC message that maps a set of global priorities to a set of local priorities used by the UE, where the one or more wireless messages are mapped from a highest local priority to a lowest local priority in accordance with a mapping between the set of global priorities and the set of local priorities. The operations of block 1610 may be performed in accordance with examples as disclosed herein. In some examples, aspects of the operations of 1610 may be performed by a signal monitoring component 925 as described with reference to FIG. 9.

At 1615, the method may include receiving a second signaling message that indicates a priority threshold, where the second signaling message indicates for the UE to adjust a communication of any wireless messages that have a priority less than the priority threshold. The operations of block 1615 may be performed in accordance with examples as disclosed herein. In some examples, aspects of the operations of 1615 may be performed by a signal monitoring component 925 as described with reference to FIG. 9.

At 1620, the method may include communicating at least a portion of the one or more wireless messages based on the priority threshold. The operations of block 1620 may be performed in accordance with examples as disclosed herein. In some examples, aspects of the operations of 1620 may be performed by a message communication component 930 as described with reference to FIG. 9.

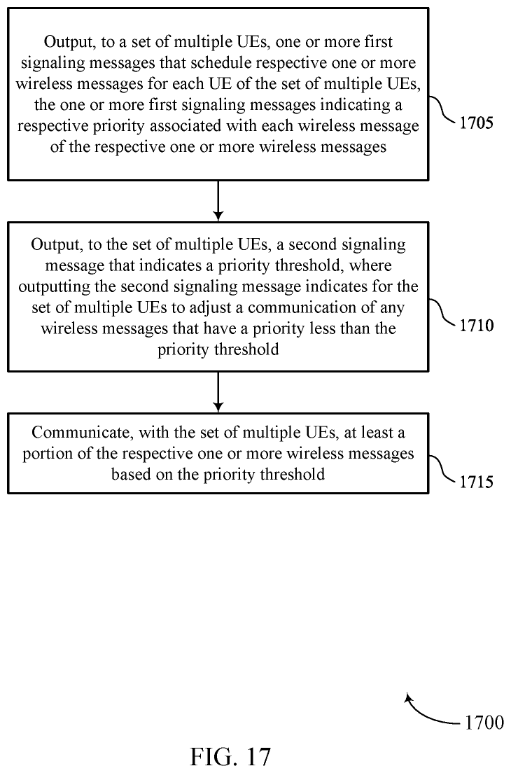

FIG. 17 shows a flowchart illustrating a method 1700 that supports prioritization and multiplexing framework in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a set of multiple user equipments (UEs), one or more first signaling messages that schedule respective one or more wireless messages for each UE of the set of multiple UEs, the one or more first signaling messages indicating a respective priority associated with each wireless message of the respective one or more wireless messages. The operations of block 1705 may be performed in accordance with examples as disclosed herein. In some examples, aspects of the operations of 1705 may be performed by a signal outputting component 1325 as described with reference to FIG. 13.

At 1710, the method may include outputting, to the set of multiple UEs, a second signaling message that indicates a priority threshold, where outputting the second signaling message indicates for the set of multiple UEs to adjust a communication of any wireless messages that have a priority less than the priority threshold. The operations of block 1710 may be performed in accordance with examples as disclosed herein. In some examples, aspects of the operations of 1710 may be performed by a signal outputting component 1325 as described with reference to FIG. 13.

At 1715, the method may include communicating, with the set of multiple UEs, at least a portion of the respective one or more wireless messages based on the priority threshold. The operations of block 1715 may be performed in accordance with examples as disclosed herein. In some examples, aspects of the operations of 1715 may be performed by a message communication component 1330 as described with reference to FIG. 13.

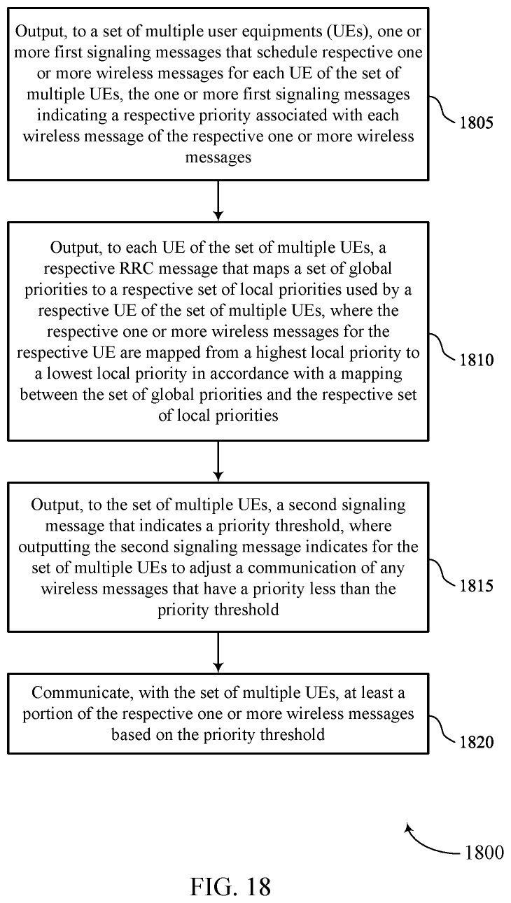

FIG. 18 shows a flowchart illustrating a method 1800 that supports prioritization and multiplexing framework in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting, to a set of multiple user equipments (UEs), one or more first signaling messages that schedule respective one or more wireless messages for each UE of the set of multiple UEs, the one or more first signaling messages indicating a respective priority associated with each wireless message of the respective one or more wireless messages. The operations of block 1805 may be performed in accordance with examples as disclosed herein. In some examples, aspects of the operations of 1805 may be performed by a signal outputting component 1325 as described with reference to FIG. 13.

At 1810, the method may include outputting, to each UE of the set of multiple UEs, a respective RRC message that maps a set of global priorities to a respective set of local priorities used by a respective UE of the set of multiple UEs, where the respective one or more wireless messages for the respective UE are mapped from a highest local priority to a lowest local priority in accordance with a mapping between the set of global priorities and the respective set of local priorities. The operations of block 1810 may be performed in accordance with examples as disclosed herein. In some examples, aspects of the operations of 1810 may be performed by a signal outputting component 1325 as described with reference to FIG. 13.

At 1815, the method may include outputting, to the set of multiple UEs, a second signaling message that indicates a priority threshold, where outputting the second signaling message indicates for the set of multiple UEs to adjust a communication of any wireless messages that have a priority less than the priority threshold. The operations of block 1815 may be performed in accordance with examples as disclosed herein. In some examples, aspects of the operations of 1815 may be performed by a signal outputting component 1325 as described with reference to FIG. 13.

At 1820, the method may include communicating, with the set of multiple UEs, at least a portion of the respective one or more wireless messages based on the priority threshold. The operations of block 1820 may be performed in accordance with examples as disclosed herein. In some examples, aspects of the operations of 1820 may be performed by a message communication component 1330 as described with reference to FIG. 13.

The following provides an overview of aspects of the present disclosure:

Aspect 1: A method for wireless communications at a UE, comprising: receiving one or more first signaling messages that schedule one or more wireless messages, the one or more first signaling messages indicating a respective priority associated with each wireless message of the one or more wireless messages; receiving a second signaling message that indicates a priority threshold, wherein the second signaling message indicates for the UE to adjust a communication of any wireless messages that have a priority less than the priority threshold; and communicating at least a portion of the one or more wireless messages based at least in part on the priority threshold.

Aspect 2: The method of aspect 1, further comprising: receiving RRC message that maps a set of global priorities to a set of local priorities used by the UE, wherein the one or more wireless messages are mapped from a highest local priority to a lowest local priority in accordance with a mapping between the set of global priorities and the set of local priorities.

Aspect 3: The method of aspect 2, wherein a first quantity of local priorities used by the UE is less than a second quantity of global priorities configured by a network entity.

Aspect 4: The method of any of aspects 1 through 3, wherein the second signaling message further indicates a region of communication resources, the method further comprising: dropping, for the region of the communication resources, a subset of wireless messages of the one or more wireless messages based at least in part on each wireless message of the subset of wireless messages being associated with respective priorities that are less than the priority threshold, wherein communicating at least the portion of the one or more wireless messages is based at least in part on the dropping.

Aspect 5: The method of aspect 4, wherein the region of the communication resources comprises a set of time resources and a set of frequency resources.

Aspect 6: The method of any of aspects 1 through 5, further comprising: receiving a signaling message of the one or more first signaling messages that configures a flexible channel, wherein the flexible channel is configurable as an uplink channel associated with a first priority or a downlink channel associated with a second priority, and wherein one of the first priority and the second priority is greater than or equal to the priority threshold; and determining that the flexible channel is the uplink channel or the downlink channel in accordance with which one of the first priority and the second priority is greater than or equal to the priority threshold, wherein communicating at least the portion of the one or more wireless messages is based at least in part on the determining.

Aspect 7: The method of any of aspects 1 through 6, wherein communicating at least the portion of the one or more wireless messages comprises: dropping a first wireless message of the one or more wireless messages that is associated with a first priority based at least in part on the first wireless message at least partially overlapping in time with a second wireless message of the one or more wireless messages that is associated with associated with a second priority greater than the first priority.

Aspect 8: The method of any of aspects 1 through 7, further comprising: receiving a third signaling message that enables multiplexing across multiple wireless messages transmitted by the UE.

Aspect 9: The method of aspect 8, further comprising: receiving a scheduling DCI message that schedules a first wireless message of the one or more wireless messages and indicates a multiplexing threshold for the first wireless message, wherein receiving the scheduling DCI message indicates for the UE to adjust the communication of the one or more wireless messages in accordance with the multiplexing threshold.

Aspect 10: The method of aspect 9, wherein adjusting the communication of the one or more wireless messages in accordance with the multiplexing threshold comprises: dropping any wireless messages that at least partially overlap in time with the first wireless message and are associated with a priority that is less than the multiplexing threshold; and multiplexing wireless messages that at least partially overlap in time with the first wireless message and are associated with respective priorities that are greater than or equal to the multiplexing threshold.

Aspect 11: The method of any of aspects 8 through 10, further comprising: receiving, as part of the one or more first signaling messages, a respective multiplexing indicator associated with each wireless message of the one or more wireless messages, wherein the respective multiplexing indicator indicates whether an associated wireless message is configured for multiplexing with other wireless messages.

Aspect 12: The method of aspect 11, further comprising: multiplexing a first wireless message of the one or more wireless messages with a second wireless message of the one or more wireless messages based at least in part on the second wireless message being associated with a respective multiplexing indicator that indicates that the second wireless message is configured for multiplexing.

Aspect 13: The method of aspect 12, further comprising: multiplexing the first wireless message with a third wireless message of the one or more wireless messages based at least in part on the third wireless message being associated with a respective multiplexing indicator that indicates that the third wireless message is configured for multiplexing.

Aspect 14: The method of any of aspects 1 through 13, wherein the second signaling message is a GC-DCI message that is associated with a plurality of UEs comprising the UE.

Aspect 15: A method for wireless communications at a network entity, comprising: outputting, to a plurality of UEs, one or more first signaling messages that schedule respective one or more wireless messages for each UE of the plurality of UEs, the one or more first signaling messages indicating a respective priority associated with each wireless message of the respective one or more wireless messages; outputting, to the plurality of UEs, a second signaling message that indicates a priority threshold, wherein outputting the second signaling message indicates for the plurality of UEs to adjust a communication of any wireless messages that have a priority less than the priority threshold; and communicating, with the plurality of UEs, at least a portion of the respective one or more wireless messages based at least in part on the priority threshold.

Aspect 16: The method of aspect 15, further comprising: outputting, to each UE of the plurality of UEs, a respective RRC message that maps a set of global priorities to a respective set of local priorities used by a respective UE of the plurality of UEs, wherein the respective one or more wireless messages for the respective UE are mapped from a highest local priority to a lowest local priority in accordance with a mapping between the set of global priorities and the respective set of local priorities.

Aspect 17: The method of any of aspects 15 through 16, wherein the second signaling message indicates for the plurality of UEs to drop wireless messages associated with respective priorities that are less than the priority threshold.

Aspect 18: The method of any of aspects 15 through 17, further comprising: outputting, to a first UE of the plurality of UEs, a signaling message of the one or more first signaling messages that configures a flexible channel, wherein the flexible channel is configurable as an uplink channel associated with a first priority or a downlink channel associated with a second priority, and wherein one of the first priority and the second priority is greater than or equal to the priority threshold; and scheduling the flexible channel as the uplink channel or the downlink channel in accordance with which one of the first priority and the second priority is greater than or equal to the priority threshold, wherein communicating at least the portion of the respective one or more wireless messages is based at least in part on the scheduling.

Aspect 19: The method of any of aspects 15 through 18, further comprising: outputting, to a first UE of the plurality of UEs, a third signaling message that enables multiplexing across multiple wireless messages outputted by the first UE.

Aspect 20: The method of aspect 19, further comprising: outputting, to the first UE, a scheduling DCI message that schedules a first wireless message of the respective one or more wireless messages and indicates a multiplexing threshold for the first wireless message, wherein outputting the scheduling DCI message indicates for the first UE to adjust the communication of the respective one or more wireless messages in accordance with the multiplexing threshold.

Aspect 21: The method of aspect 20, wherein the multiplexing threshold indicates for the first UE to drop any wireless messages that at least partially overlap in time with the first wireless message and are associated with a priority that is less than the multiplexing threshold, and to multiplex any wireless messages that at least partially overlap in time with the first wireless message and are associated with respective priorities that are greater than or equal to the multiplexing threshold.

Aspect 22: The method of any of aspects 19 through 21, further comprising: outputting, as part of the one or more first signaling messages, a respective multiplexing indicator associated with each wireless message of the respective one or more wireless messages associated with the first UE, wherein the respective multiplexing indicator indicates whether an associated wireless message is configured for multiplexing with other wireless messages.

Aspect 23: The method of any of aspects 15 through 22, wherein the second signaling message is a GC-DCI message that is associated with the plurality of UEs.

Aspect 24: A UE for wireless communications, comprising one or more memories storing processor-executable code, and one or more processors coupled with the one or more memories and individually or collectively operable to execute the code to cause the UE to perform a method of any of aspects 1 through 14.

Aspect 25: A UE for wireless communications, comprising at least one means for performing a method of any of aspects 1 through 14.

Aspect 26: A non-transitory computer-readable medium storing code for wireless communications, the code comprising instructions executable by one or more processors to perform a method of any of aspects 1 through 14.

Aspect 27: A network entity for wireless communications, comprising one or more memories storing processor-executable code, and one or more processors coupled with the one or more memories and individually or collectively operable to execute the code to cause the network entity to perform a method of any of aspects 15 through 23.

Aspect 28: A network entity for wireless communications, comprising at least one means for performing a method of any of aspects 15 through 23.

Aspect 29: A non-transitory computer-readable medium storing code for wireless communications, the code comprising instructions executable by one or more processors to perform a method of any of aspects 15 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more first signaling messages that schedule one or more wireless messages, the one or more first signaling messages indicating a respective priority associated with each wireless message of the one or more wireless messages;
receive a second signaling message that indicates a priority threshold, wherein the second signaling message indicates for the UE to adjust a communication of any wireless messages that have a priority less than the priority threshold; and
communicate at least a portion of the one or more wireless messages based at least in part on the priority threshold.

2. The UE of claim 1, wherein the one or more processors are individually or collectively further operable to execute the code to cause the UE to:
receive a radio resource control message that maps a set of global priorities to a set of local priorities used by the UE, wherein the one or more wireless messages are mapped from a highest local priority to a lowest local priority in accordance with a mapping between the set of global priorities and the set of local priorities.

3. The UE of claim 2, wherein a first quantity of local priorities used by the UE is less than a second quantity of global priorities configured by a network entity.

4. The UE of claim 1, wherein the second signaling message further indicates a region of communication resources, and the one or more processors are individually or collectively further operable to execute the code to cause the UE to:
drop, for the region of the communication resources, a subset of wireless messages of the one or more wireless messages based at least in part on each wireless message of the subset of wireless messages being associated with respective priorities that are less than the priority threshold, wherein communication of at least the portion of the one or more wireless messages is based at least in part on the subset of wireless messages being dropped.

5. The UE of claim 4, wherein the region of the communication resources comprises a set of time resources and a set of frequency resources.

6. The UE of claim 1, wherein the one or more processors are individually or collectively further operable to execute the code to cause the UE to:
receive a signaling message of the one or more first signaling messages that configures a flexible channel, wherein the flexible channel is configurable as an uplink channel associated with a first priority or a downlink channel associated with a second priority, and wherein one of the first priority and the second priority is greater than or equal to the priority threshold; and
determine that the flexible channel is the uplink channel or the downlink channel in accordance with which one of the first priority and the second priority is greater than or equal to the priority threshold, wherein communication of at least the portion of the one or more wireless messages is based at least in part on the determination.

7. The UE of claim 1, wherein, to communicate at least the portion of the one or more wireless messages, the one or more processors are individually or collectively operable to execute the code to cause the UE to:
drop a first wireless message of the one or more wireless messages that is associated with a first priority based at least in part on the first wireless message at least partially overlapping in time with a second wireless message of the one or more wireless messages that is associated with associated with a second priority greater than the first priority.

8. The UE of claim 1, wherein the one or more processors are individually or collectively further operable to execute the code to cause the UE to:
receive a third signaling message that enables multiplexing across multiple wireless messages transmitted by the UE.

9. The UE of claim 8, wherein the one or more processors are individually or collectively further operable to execute the code to cause the UE to:
receive a scheduling downlink control information message that schedules a first wireless message of the one or more wireless messages and indicates a multiplexing threshold for the first wireless message, wherein reception of the scheduling downlink control information message indicates for the UE to adjust the communication of the one or more wireless messages in accordance with the multiplexing threshold.

10. The UE of claim 9, wherein, to adjust the communication of the one or more wireless messages in accordance with the multiplexing threshold, the one or more processors are individually or collectively operable to execute the code to cause the UE to:
drop any wireless messages that at least partially overlap in time with the first wireless message and are associated with a priority that is less than the multiplexing threshold; and
multiplex wireless messages that at least partially overlap in time with the first wireless message and are associated with respective priorities that are greater than or equal to the multiplexing threshold.

11. The UE of claim 8, wherein the one or more processors are individually or collectively further operable to execute the code to cause the UE to:
receive, as part of the one or more first signaling messages, a respective multiplexing indicator associated with each wireless message of the one or more wireless messages, wherein the respective multiplexing indicator indicates whether an associated wireless message is configured for multiplexing with other wireless messages.

12. The UE of claim 11, wherein the one or more processors are individually or collectively further operable to execute the code to cause the UE to:
multiplex a first wireless message of the one or more wireless messages with a second wireless message of the one or more wireless messages based at least in part on the second wireless message being associated with a respective multiplexing indicator that indicates that the second wireless message is configured for multiplexing.

13. The UE of claim 12, wherein the one or more processors are individually or collectively further operable to execute the code to cause the UE to:
multiplex the first wireless message with a third wireless message of the one or more wireless messages based at least in part on the third wireless message being associated with a respective multiplexing indicator that indicates that the third wireless message is configured for multiplexing.

14. The UE of claim 1, wherein the second signaling message is a group common downlink control information message that is associated with a plurality of UEs comprising the UE.

15. A network entity, comprising:
one or more memories storing processor-executable code; and
one or more processors coupled with the one or more memories and individually or collectively operable to execute the code to cause the network entity to:
output, to a plurality of user equipments (UEs), one or more first signaling messages that schedule respective one or more wireless messages for each UE of the plurality of UEs, the one or more first signaling messages indicating a respective priority associated with each wireless message of the respective one or more wireless messages;
output, to the plurality of UEs, a second signaling message that indicates a priority threshold, wherein outputting the second signaling message indicates for the plurality of UEs to adjust a communication of any wireless messages that have a priority less than the priority threshold; and
communicate, with the plurality of UEs, at least a portion of the respective one or more wireless messages based at least in part on the priority threshold.

16. The network entity of claim 15, wherein the one or more processors are individually or collectively further operable to execute the code to cause the network entity to:
output, to each UE of the plurality of UEs, a respective radio resource control message that maps a set of global priorities to a respective set of local priorities used by a respective UE of the plurality of UEs, wherein the respective one or more wireless messages for the respective UE are mapped from a highest local priority to a lowest local priority in accordance with a mapping between the set of global priorities and the respective set of local priorities.

17. The network entity of claim 15, wherein the second signaling message indicates for the plurality of UEs to drop wireless messages associated with respective priorities that are less than the priority threshold.

18. The network entity of claim 15, wherein the one or more processors are individually or collectively further operable to execute the code to cause the network entity to:
output, to a first UE of the plurality of UEs, a signaling message of the one or more first signaling messages that configures a flexible channel, wherein the flexible channel is configurable as an uplink channel associated with a first priority or a downlink channel associated with a second priority, and wherein one of the first priority and the second priority is greater than or equal to the priority threshold; and
schedule the flexible channel as the uplink channel or the downlink channel in accordance with which one of the first priority and the second priority is greater than or equal to the priority threshold, wherein communicating at least the portion of the respective one or more wireless messages is based at least in part on the flexible channel being scheduled.

19. The network entity of claim 15, wherein the one or more processors are individually or collectively further operable to execute the code to cause the network entity to:
output, to a first UE of the plurality of UEs, a third signaling message that enables multiplexing across multiple wireless messages outputted by the first UE.

20. The network entity of claim 19, wherein the one or more processors are individually or collectively further operable to execute the code to cause the network entity to:
output, to the first UE, a scheduling downlink control information message that schedules a first wireless message of the respective one or more wireless messages and indicates a multiplexing threshold for the first wireless message, wherein output of the scheduling downlink control information message indicates for the first UE to adjust the communication of the respective one or more wireless messages in accordance with the multiplexing threshold.

21. The network entity of claim 20, wherein the multiplexing threshold indicates for the first UE to drop any wireless messages that at least partially overlap in time with the first wireless message and are associated with a priority that is less than the multiplexing threshold, and to multiplex any wireless messages that at least partially overlap in time with the first wireless message and are associated with respective priorities that are greater than or equal to the multiplexing threshold.

22. The network entity of claim 19, wherein the one or more processors are individually or collectively further operable to execute the code to cause the network entity to:
output, as part of the one or more first signaling messages, a respective multiplexing indicator associated with each wireless message of the respective one or more wireless messages associated with the first UE, wherein the respective multiplexing indicator indicates whether an associated wireless message is configured for multiplexing with other wireless messages.

23. The network entity of claim 15, wherein the second signaling message is a group common downlink control information message that is associated with the plurality of UEs.

24. A method for wireless communications at a user equipment (UE), comprising:
receiving one or more first signaling messages that schedule one or more wireless messages, the one or more first signaling messages indicating a respective priority associated with each wireless message of the one or more wireless messages;
receiving a second signaling message that indicates a priority threshold, wherein the second signaling message indicates for the UE to adjust a communication of any wireless messages that have a priority less than the priority threshold; and
communicating at least a portion of the one or more wireless messages based at least in part on the priority threshold.

25. The method of claim 24, further comprising:
receiving a radio resource control message that maps a set of global priorities to a set of local priorities used by the UE, wherein the one or more wireless messages are mapped from a highest local priority to a lowest local priority in accordance with a mapping between the set of global priorities and the set of local priorities.

26. The method of claim 25, wherein a first quantity of local priorities used by the UE is less than a second quantity of global priorities configured by a network entity.

27. The method of claim 24, wherein the second signaling message further indicates a region of communication resources, the method further comprising:
dropping, for the region of the communication resources, a subset of wireless messages of the one or more wireless messages based at least in part on each wireless message of the subset of wireless messages being associated with respective priorities that are less than the priority threshold, wherein communicating at least the portion of the one or more wireless messages is based at least in part on the dropping.

28. The method of claim 27, wherein the region of the communication resources comprises a set of time resources and a set of frequency resources.

29. The method of claim 24, further comprising:
receiving a signaling message of the one or more first signaling messages that configures a flexible channel, wherein the flexible channel is configurable as an uplink channel associated with a first priority or a downlink channel associated with a second priority, and wherein one of the first priority and the second priority is greater than or equal to the priority threshold; and
determining that the flexible channel is the uplink channel or the downlink channel in accordance with which one of the first priority and the second priority is greater than or equal to the priority threshold, wherein communicating at least the portion of the one or more wireless messages is based at least in part on the determining.

30. A method for wireless communications at a network entity, comprising:
outputting, to a plurality of user equipments (UEs), one or more first signaling messages that schedule respective one or more wireless messages for each UE of the plurality of UEs, the one or more first signaling messages indicating a respective priority associated with each wireless message of the respective one or more wireless messages;
outputting, to the plurality of UEs, a second signaling message that indicates a priority threshold, wherein outputting the second signaling message indicates for the plurality of UEs to adjust a communication of any wireless messages that have a priority less than the priority threshold; and
communicating, with the plurality of UEs, at least a portion of the respective one or more wireless messages based at least in part on the priority threshold.
